(19) United States
(12) Patent Application Publication
(10) Pub. No.: US 2023/0146825 A1
(43) Pub. Date: May 11, 2023

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 17/983,415

(22) Filed: Nov. 9, 2022

(30) Foreign Application Priority Data
Nov. 10, 2021 (CN) 202111324873.4

(51) Int. Cl. H04W 76/18; H04W 24/08

(52) U.S. Cl. CPC H04W 76/18; H04W 24/08

(57) ABSTRACT

Disclosure provides method and device used in communication node for wireless communications. A communication node transmits a first message, the first message being used to request a first RRC connection procedure; accompanying the first message, starts a first timer; determines that the first RRC connection procedure is failed; stores first failure information in a first variant; when the first message is transmitted, the first node is not in an RRC_CONNECTED State; the first failure information comprises a first measurement result; the first condition is that the first timer expires and the first timer is a target timer, and the first failure information does not comprises the first information; or, the first condition is any condition in a first condition set, and the first failure information comprises the first information.

### CROSS REFERENCE TO RELATED APPLICATIONS

This application claims the priority benefit of Chinese Patent Application No. 202111324873.4, filed on Nov. 10, 2021, the full disclosure of which is incorporated herein by reference.

### BACKGROUND

### Technical Field

The present application relates to transmission methods and devices in wireless communication systems, and in particular to a transmission scheme and device related to a Small Data Transmission (SDT) failure report in wireless communications.

### Related Art

New Radio (NR) supports Radio Resource Control (RRC)_INACTIVE State, and RRC_INACTIVE State does not support transmitting data until 3GPP Rel-16 version. 3GPP RAN #86th meeting decided to carry out a Work Item (WI) of “Small Data Transmission (SDT) in NR_INACTIVE State” to study SDT technology in RRC_INACTIVE State, comprising transmitting uplink data on pre-configured Physical Uplink Shared Channel (PUSCH) resources, or utilizing Message 3 (Msg3) or Message B (MsgB) in a Random Access (RA) procedure to carry data (called RA-SDT for simplicity). 3GPP system supports self-optimization function, that is, if a User Equipment (UE) has a Radio Link Failure (RLF) or a Handover Failure (HOF) in RRC_CONNECTED State, or an RRC Connection Resume failure in RRC_INACTIVE state, or an RRC Connection Establishment failure in RRC_IDLE state, the UE then stores failure information and reports failure information according to scheduling of a base station, so as to optimize network performance.

### SUMMARY

A UE fails to execute an SDT in RRC_INACTIVE state, which does not meet the storage conditions for failure information specified in the current protocol, so SDT failure information cannot be stored. When the UE fails to execute an SDT in RRC_INACTIVE state, and if the SDT information is not recorded, it is not conducive for the base station to optimize configuration of the SDT. Therefore, the storage and reporting of failure information that the UE fails to execute an SDT in RRC_INACTIVE state needs to be enhanced.

To address the above problem, the present application provides a solution. For the description of the above problem, the SDT scenario adopting NR RRC_INACTIVE state is used as an example; the application is also applicable to scenarios such as LTE NarrowBand Internet of Things (NB-IoT) or SideLink (SL) transmission, where similar technical effects can be achieved. Additionally, the adoption of a unified solution for various scenarios contributes to the reduction of hardware complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:

transmitting a first message on a first cell, the first message being used to request a first RRC connection procedure; accompanying the first message, starting a first timer; and

as a response to a first condition being satisfied, determining the first RRC connection procedure failure; as a response to determining the first RRC connection procedure failure, storing first failure information in a first variant;

herein, when the first message is transmitted, the first node is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T319.

In one embodiment, the first node is in an RRC_INACTIVATE State.

The present application provides a method in a first node for wireless communications, comprising:

transmitting a first message on a first cell, the first message being used to request a first RRC connection procedure; accompanying the first message, starting a first timer; and

as a response to a first condition being satisfied, determining the first RRC connection procedure failure; as a response to determining the first RRC connection procedure failure, storing first failure information in a first variant;

herein, when the first message is transmitted, the first node is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T300.

In one embodiment, the first node is in an RRC_IDLE State.

Typically, when the first message is transmitted, the first node is in RRC_INACTIVE State.

In one embodiment, a problem to be solved in the present application includes: according to the existing protocol, if the first condition is any condition in the first condition set, the first failure information cannot be recorded.

In one embodiment, a problem to be solved in the present application includes: if the first condition is any condition in the first condition set, how to store the first failure information.

In one embodiment, a problem to be solved in the present application includes: if the first condition is any condition in the first condition set, how to determine contents in the first failure information.

In one embodiment, characteristics of the above method comprise: the first condition is first failure information when the first timer expires and the first timer is a target timer being different from first failure information when the first condition is any condition in the first condition set.

In one embodiment, characteristics of the above method comprise: if the first condition is any condition in the first condition set, the first failure information comprises at least the first information.

In one embodiment, characteristics of the above method comprise: if the first condition is any condition in the first condition set, the first failure information is stored.

In one embodiment, characteristics of the above method comprise: if the first condition is any condition in the first condition set, the existing variant is multiplexed to store the first failure information.

In one embodiment, characteristics of the above method comprise: if the first condition is any condition in the first condition set, a new variant is used to store the first failure information.

In one embodiment, advantages of the above method include: it is conducive to network coverage optimization.

In one embodiment, advantages of the above method include: it is conducive to mobility enhancement.

In one embodiment, advantages of the above method include: it is conducive to SDT configuration optimization.

In one embodiment, advantages of the above method include: it is conducive to SDT enhancement.

According to one aspect of the present application, it is characterized in that the first variant is associated with that the first timer expires and the first timer is the target timer, and name of the first variant comprises VarConnEstFailReport; or, the first condition is any condition in the first condition set, and the first variant is a first candidate variant.

Typically, the second candidate variant is an RRC-layer variant.

In one embodiment, the first candidate variant is a VarRLF-Report.

In one embodiment, the first candidate variant is a variant other than a VarConnEstFailReport and a VarRLF-Report.

According to one aspect of the present application, it is characterized in that the first variant is associated with that the first timer expires and the first timer is the target timer, and name of the first variant comprises VarConnEstFailReport.

In one embodiment, characteristics of the above method comprise: if the first condition is any condition in the first condition set, the first failure information is stored in VarConnEstFailReport.

According to one aspect of the present application, it is characterized in that the first condition is any condition in the first condition set, and the first variant is a first candidate variant.

In one embodiment, characteristics of the above method comprise: if the first condition is any condition in the first condition set, the first failure information is stored in a VarRLF-Report.

In one embodiment, characteristics of the above method comprise: if the first condition is any condition in the first condition set, the first failure information is stored in a variant other than a VarConnEstFailReport and a VarRLF-Report.

According to one aspect of the present application, it is characterized in that conditions in the first condition set also comprise at least one of Radio Link Control (RLC) retransmissions reaching a maximum number, or timer T310 being expired, or occurring Listen Before Talk (LBT) failure, or occurring Beam Failure Recovery (BFR) failure, or occurring random access failure.

According to one aspect of the present application, it is characterized in that the first information comprises first sub-information, and the first sub-information is used to indicate the first condition.

According to one aspect of the present application, it is characterized in that the first information comprises second sub-information, and the second sub-information is used to determine whether a type of the first RRC connection procedure is a first type or a second type; if the type of the first RRC connection procedure is the first type, the first message is transmitted in a random access procedure; and if the type of the first RRC connection procedure is the second type, the first message is transmitted on pre-configured uplink resources.

According to one aspect of the present application, it is characterized in that if the type of the first RRC connection procedure is the second type, the first information comprises third sub-information, the third sub-information is used to indicate that second information is not satisfied, and the second condition is any condition in a second condition set; the second condition not being satisfied is used to determine that the type of the first RRC connection procedure is the first type; all conditions in the second condition set being satisfied is used to determine that a type of the first RRC connection procedure is the second type.

According to one aspect of the present application, it is characterized in that whether the first failure information comprises second information is related to at least a former of the first condition and the type of the first RRC connection procedure; the second information is used to indicate random access information.

According to one aspect of the present application, comprising:

after the first RRC connection procedure is determined failed, transmitting a second message on a second cell, the second message being used to request a second RRC connection procedure; accompany the second message, starting a second timer; and

as a response to the second timer being expired, determining the second RRC connection procedure failure; as a response to determining the second RRC connection procedure failure, clearing target information in the first variant, and storing second failure information in the first variant;

herein, the second failure information comprises a second measurement result, and the second measurement result is associated with the second cell; the target information does not comprise at least partial information in the first failure information.

In one embodiment, a receiver of the second message is different from a receiver of the first message.

In one embodiment, a receiver of the second message is the same as a receiver of the first message.

According to one aspect of the present application, comprising:

as a response to determining the first RRC connection procedure failure, determining whether a first counter is increased by 1 according to whether the first RRC connection procedure is used for an SDT;

herein, the first variant comprises the first counter; the behavior of whether the first counter is increased by 1 according to whether the first RRC connection procedure is used for an SDT comprises: if the first RRC connection procedure is not used for an SDT, increasing the first counter by 1; if the first RRC connection procedure is used for an SDT, not increasing the first counter by 1.

In one embodiment, as a response to determining the first RRC connection procedure failure, a first counter is increased by 1.

In one subembodiment of the embodiment, if the first RRC connection procedure is not used for an SDT, the first counter is increased by 1; if the first RRC connection procedure is used for an SDT, the first counter is increased by 1.

In one embodiment, during when the first timer is running, a candidate message is monitored.

In one embodiment, as a response to receiving the target signaling, a first-type sub-message is transmitted.

In one embodiment, as a response to the first-type sub-message being transmitted, a first-type sub-signaling is received.

In one embodiment, as a response to the first message being transmitted, a target signaling is received.

In one embodiment, accompanying the first-type sub-message, the first timer is restarted.

In one embodiment, a third message is transmitted, and the third message indicates whether there exists the first failure information.

In one embodiment, a receiver of the third message is different from a receiver of the first message.

In one embodiment, a receiver of the third message is the same as a receiver of the first message.

In one embodiment, a fourth message is received, and the fourth message is used to request reporting the first failure information; as a response to receiving the fourth message, a fifth message is transmitted, and the fifth message comprises the first failure information.

In one embodiment, a transmitter of the fourth message is the same as a receiver of the fifth message.

In one embodiment, a transmitter of the fourth message is different from a receiver of the third message.

In one embodiment, a transmitter of the fourth message is the same as a receiver of the third message.

The present application provides a method in a second node for wireless communications, comprising:

receiving a first message on a first cell, the first message being used to request a first RRC connection procedure;

herein, accompanying the first message, a first timer is started; as a response to a first condition being satisfied, the first RRC connection procedure is determined to be failed; as a response to that the first RRC connection procedure is determined to be failed, first failure information is stored in a first variant; when the first message is transmitted, a transmitter of the first message is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T319, or the target timer is T300.

According to one aspect of the present application, it is characterized in that the first variant is associated with that the first timer expires and the first timer is the target timer, and name of the first variant comprises VarConnEstFailReport; or, the first condition is any condition in the first condition set, and the first variant is a first candidate variant.

According to one aspect of the present application, it is characterized in that conditions in the first condition set also comprise at least one of a maximum number of RLC retransmissions having been reached, or timer T310 being expired, or occurring LBT failure, or occurring BFR failure, or occurring random access failure.

According to one aspect of the present application, it is characterized in that the first information comprises first sub-information, and the first sub-information is used to indicate the first condition.

According to one aspect of the present application, it is characterized in that the first information comprises second sub-information, and the second sub-information is used to determine whether a type of the first RRC connection procedure is a first type or a second type; if the type of the first RRC connection procedure is the first type, the first message is transmitted in a random access procedure; if the type of the first RRC connection procedure is the second type, the first message is transmitted on pre-configured uplink resources.

According to one aspect of the present application, it is characterized in that if the type of the first RRC connection procedure is the second type, the first information comprises third sub-information, the third sub-information is used to indicate that second information is not satisfied, and the second condition is any condition in a second condition set; the second condition not being satisfied is used to determine that the type of the first RRC connection procedure is the first type; all conditions in the second condition set being satisfied is used to determine that the type of the first RRC connection procedure is the second type.

According to one aspect of the present application, it is characterized in that whether the first failure information comprises second information is related to at least a former of the first condition and the type of the first RRC connection procedure; the second information is used to indicate random access information.

According to one aspect of the present application, it is characterized in that a second message is received on a second cell, and the second message is used to request a second RRC connection procedure; after the first RRC connection procedure is determined failed, the second message is triggered; accompanying the second message, a second timer is started; as a response to the second timer being expired, the second RRC connection procedure is determined failed; as a response to the second RRC connection procedure being determined failed, target information in the first variant is cleared, and second failure information is stored in the first variant; the second failure information comprises a second measurement result, and the second measurement result is associated with the second cell; the target information does not comprise at least partial information in the first failure information.

According to one aspect of the present application, it is characterized in that as a response to the first RRC connection procedure being determined failed, whether the first RRC connection procedure is used for an SDT is used to determine whether a first counter is increased by 1; the first variant comprises the first counter; the phrase of whether the first RRC connection procedure is used for an SDT being used to determine whether a first counter is increased by 1 comprises: if the first RRC connection procedure is not used for an SDT, the first counter is increased by 1; if the first RRC connection procedure is used for an SDT, the first counter is not increased by 1.

In one embodiment, after the first message is received, a candidate message is transmitted.

In one embodiment, as a response to transmitting the target signaling, a first-type sub-message is received.

In one embodiment, as a response to the first-type sub-message being received, a first-type sub-signaling is transmitted.

In one embodiment, as a response to the first message being received, a target signaling is transmitted.

The present application provides a first node for wireless communications, comprising:

a first transmitter, transmitting a first message on a first cell, the first message being used to request a first RRC connection procedure; accompanying the first message, starting a first timer;

a first receiver, as a response to a first condition being satisfied, determining the first RRC connection procedure failure; as a response to determining the first RRC connection procedure failure, storing first failure information in a first variant;

herein, when the first message is transmitted, the first node is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T319, or the target timer is T300.

The present application provides a second node for wireless communications, comprising:

a second receiver, receiving a first message on a first cell, the first message being used to request a first RRC connection procedure;

herein, accompanying the first message, a first timer is started; as a response to a first condition being satisfied, the first RRC connection procedure is determined to be failed; as a response to that the first RRC connection procedure is determined to be failed, first failure information is stored in a first variant; when the first message is transmitted, a transmitter of the first message is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T319, or the target timer is T300.

In one embodiment, the present application has the following advantages over conventional schemes:

it is conducive to network coverage optimization;

it is conducive to mobility enhancement;

it is conducive to SDT configuration optimization;

it is conducive to SDT enhancement.

### BRIEF DESCRIPTION OF THE DRAWINGS

Other features, objects and advantages of the present application will become more apparent from the detailed description of non-restrictive embodiments taken in conjunction with the following drawings:

FIG. 1 is a flowchart of transmission of a first message according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a flowchart of radio signal transmission according to another embodiment of the present application;

FIG. 7 illustrates a flowchart of radio signal transmission according to another embodiment of the present application;

FIG. 8 illustrates a schematic diagram of first information comprising first sub-information according to one embodiment of the present application;

FIG. 9 illustrates a schematic diagram of first information comprising second sub-information according to one embodiment of the present application;

FIG. 10 illustrates a schematic diagram of first information comprising third sub-information according to one embodiment of the present application;

FIG. 11 illustrates a schematic diagram of whether first failure information comprises second information being related to at least a former of a first condition and a first RRC connection procedure according to one embodiment of the present application;

FIG. 12 illustrates a structure block diagram of a processor in a first node according to one embodiment of the present application;

FIG. 13 illustrates a structure block diagram of a processor in a second node according to one embodiment of the present application;

FIG. 14 illustrates a flowchart of radio signal transmission according to another embodiment of the present application;

FIG. 15 illustrates a flowchart of radio signal transmission according to another embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

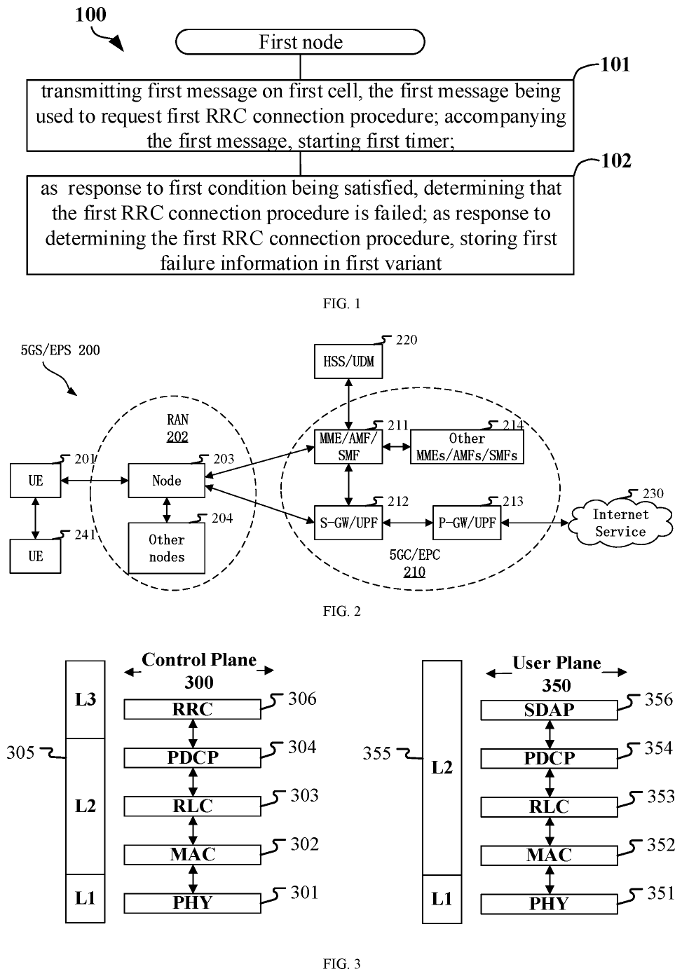

Embodiment 1 illustrates a flowchart of transmission of a first message according to one embodiment of the present application, as shown in FIG. 1. In FIG. 1, each step represents a step, it should be particularly noted that the sequence order of each box herein does not imply a chronological order of steps marked respectively by these boxes.

In embodiment 1, a first node in the present application in step 101 transmits a first message on a first cell, the first message is used to request a first RRC connection procedure; accompanying the first message, starts a first timer; in step 102, as a response to a first condition being satisfied, determines the first RRC connection procedure failure; as a response to determining the first RRC connection procedure failure, stores first failure information in a first variant; herein, when the first message is transmitted, the first node is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise first information; or, the first condition is any condition in a first condition set, and the first failure information comprises first information; one condition in the first condition set is that the first timer expires and the first timer is a timer other than a target timer; the target timer is T319, or the target timer is T300.

In one embodiment, the first cell is a Primary Cell (PCell).

In one embodiment, the first cell is a Primary SCG (Secondary Cell Group) Cell (PSCell).

In one embodiment, the first cell is a PCell, and a cell group to which the first cell belongs is a Master Cell Group (MCG).

In one embodiment, the first cell is a PSCell, and a cell group to which the first cell belongs is a Secondary Cell Group (SCG).

In one embodiment, a Signalling Radio Bearer (SRB) of the first message is SRB0.

In one embodiment, a logical channel of the first message comprises a Common Control Channel (CCCH).

In one embodiment, the first message is an Uplink (UL) message.

In one embodiment, the first message is a DownLink (DL) message.

In one embodiment, the first message is transmitted through Message 3 (Msg3).

In one embodiment, the first message is transmitted through Message A (MsgA).

In one embodiment, the first message is transmitted in a random access procedure.

In one embodiment, the first message is not transmitted in a random access procedure.

In one embodiment, the first message is transmitted on pre-configured Physical Uplink Shared Channel (PUSCH) resources.

In one embodiment, if the first message is transmitted, the first node is in an RRC-INACTIVE state, and the first node maintains an RNA.

In one subembodiment of the embodiment, the first cell is a cell in a Radio Access Network (RNA)-based Notification Area maintained by the first node.

In one subembodiment of the embodiment, the first node is configured with an RNA, the RNA comprises a cell list, and the first cell is a cell in the cell list.

In one subembodiment of the embodiment, the first node is configured with an RNA, the RNA comprises a List of RAN areas, and the first cell belongs to an RAN area in the List of RAN areas.

In one subembodiment of the embodiment, when the first message is transmitted, a maintenance base station of the first cell comprises contents of the first node.

In one subembodiment of the embodiment, when the first message is transmitted, a maintenance base station of the first cell does not comprise contents of the first node.

In one embodiment, the first message comprises an RRCResumeRequest message or the first message comprises an RRCResumeRequest1 message.

In one subembodiment of the above embodiment, the first message comprises an RRC field, and the RRC field indicates an identifier of the first node.

In one subsidiary embodiment of the subembodiment, name of the RRC field comprises resumeIdentity.

In one subsidiary embodiment of the subembodiment, the identifier of the first node is indicated by an RRC Information Element (IE), and name of the RRC IE comprises ShortI-RNTI-Value.

In one subsidiary embodiment of the subembodiment, the identifier of the first node is indicated by an RRC IE, and name of the RRC IE comprises I-RNTI-Value.

In one subsidiary embodiment of the subembodiment, the identifier of the first node comprises a bit string, the bit string comprises K1 bit(s), K1 being a positive integer, and K1 being not greater than 128.

In one subsidiary embodiment of the subembodiment, the above K1 is equal to 24.

In one subsidiary embodiment of the subembodiment, the above K1 is equal to 40.

In one subembodiment of the above embodiment, the first message comprises an RRC field, and the RRC field indicates an authentication token used for UE authentication at the second node.

In one subsidiary embodiment of the subembodiment, name of the RRC field comprises resumeMAC-I.

In one subsidiary embodiment of the subembodiment, a value of the RRC field is set as a bit string, and the bit string comprises K2 bit(s), K2 being a positive integer, K2 being not greater than 128.

In one subsidiary embodiment of the above embodiment, the above K2 is equal to 16.

In one subsidiary embodiment of the above embodiment, K2 is equal to 24.

In one subembodiment of the above embodiment, the first message comprises an RRC field, and the RRC field indicates a cause for initiating the first RRC connection procedure.

In one subsidiary embodiment of the subembodiment, name of the RRC field comprises resumeCause.

In one subsidiary embodiment of the subembodiment, a value of the RRC field is set as at least one of emergency or highPriorityAccess or mt-Access or mo-Signalling or mo-Data or mo-VoiceCall or mo-VideoCall or mo-SMS or ma-Update or mps-PriorityAccess or mcs-PriorityAccess.

In one subsidiary embodiment of the subembodiment, a value of the RRC field is set as a value whose names comprising at least one of sdt or idt or small or data or transmission or inactive.

In one subsidiary embodiment of the subembodiment, the first message does not comprise an RRC field indicating a cause for initiating the first RRC connection procedure.

In one subembodiment of the above embodiment, the first message comprises an RRC field, name of the RRC field comprises resumeCause, and the RRC field is used to indicate a BSR.

In one subembodiment of the above embodiment, the first message comprises an RRC field, name of the RRC field comprises resumeCause, and the RRC field is used to indicate a PHR.

In one embodiment, the first message comprises an RRCSetupRequest message.

In one subembodiment of the above embodiment, the first message comprises an RRC field, the RRC field indicates a cause for initiating the first RRC connection procedure, and name of the RRC field comprises establishmentCause.

In one subembodiment of the above embodiment, the first message comprises an RRC field, the RRC field indicates an identifier of the first node, and name of the RRC field comprises InitialUE-Identity.

In one embodiment, the first RRC connection procedure is an SDT procedure; the first message comprises an RRCResumeRequest message or the first message comprises an RRCResumeRequest1 message.

In one embodiment, the first RRC connection procedure is not an SDT procedure and the first RRC connection procedure is used for an RRC connection resume; the first message comprises an RRCResumeRequest message or the first message comprises an RRCResumeRequest1 message.

In one embodiment, the first RRC connection procedure is not an SDT procedure and the first RRC connection procedure is used for an RRC connection establishment; the first message comprises an RRCSetupRequest message.

In one embodiment, the first RRC connection procedure is used for an SDT.

In one subembodiment of the above embodiment, the first RRC connection procedure comprises an SDT procedure.

In one subembodiment of the above embodiment, the first RRC connection procedure is an SDT procedure.

In one subembodiment of the above embodiment, if the first message is transmitted in a random access procedure, and a random access preamble adopted in the random access procedure is used for an SDT, the first RRC connection procedure is used for an SDT.

In one subembodiment of the above embodiment, if the first message is transmitted on pre-configured uplink resources, the first RRC connection procedure is used for an SDT.

In one subembodiment of the above embodiment, if the first message is transmitted on pre-configured uplink resources, and the pre-configured uplink resources are used for an SDT, the first RRC connection procedure is used for an SDT.

In one embodiment, the first RRC connection procedure is not used for an SDT.

In one subembodiment of the above embodiment, the first RRC connection procedure is executed in an RRC_IDLE state.

In one subembodiment of the above embodiment, the first RRC connection procedure comprises an RRC connection establishment procedure in an RRC_IDLE state.

In one subembodiment of the above embodiment, the first RRC connection procedure is executed in an RRC_INACTIVE state.

In one subembodiment of the above embodiment, the first RRC connection procedure comprises an RRC connection resume procedure in an RRC_INACTIVE state.

In one subembodiment of the above embodiment, the first RRC connection procedure is not an SDT procedure.

In one subembodiment of the above embodiment, the first RRC connection procedure comprises an RRC connection resume procedure.

In one subembodiment of the above embodiment, the first RRC connection procedure comprises an RRC connection establishment procedure.

In one subembodiment of the above embodiment, the first RRC connection procedure is used for an RRC connection establishment.

In one subembodiment of the above embodiment, the first RRC connection procedure is used for an RRC connection resume.

In one embodiment, the phrase of accompanying the first message comprises when the first message is transmitted.

In one embodiment, the phrase of accompanying the first message comprises when contents of the first message are set.

In one embodiment, the phrase of accompanying the first message comprises when the first message is delivered to a lower layer at an RRC layer.

In one embodiment, the phrase of accompanying the first message comprises following the first message.

In one embodiment, the phrase of accompanying the first message comprises immediately following the first message.

In one embodiment, the phrase of accompanying the first message comprises when the first message is triggered.

In one embodiment, the phrase of accompanying the first message comprises just before the first message is transmitted.

In one embodiment, the phrase of accompanying the first message comprises just after the first message is transmitted.

In one embodiment, an SDT comprises that the first node uses a DRB transmission data packet in an RRC-INACTIVE State.

In one embodiment, an SDT comprises that the first node resumes a DRB in an RRC-INACTIVE State, and uses a DRB transmission data packet.

In one embodiment, an SDT comprises that the first node transmits a data packet through an MSG3 or MSGA or dynamically-scheduled or pre-configured uplink resources in RRC_INACTIVE State.

In one embodiment, if the first RRC connection procedure is used for an SDT, accompanying the first message, a first bearer is resumed, and the first bearer is a Data Radio Bearer (DRB).

In one embodiment, if the first RRC connection procedure is used for an SDT, accompanying the first message, a PDCP entity of an SRB1 is re-established and the SRB1 is resumed; a PDCP entity of a first bearer is re-established and the first bearer is resumed.

In one embodiment, if the first RRC connection procedure is not used for an SDT, accompanying the first message, any DRB is not resumed.

In one embodiment, if the first RRC connection procedure is not used for an SDT, accompanying the first message, a PDCP entity of an SRB1 is re-established and the SRB1 is resumed; a PDCP entity of the first bearer is not re-established and the first bearer is not resumed.

In one embodiment, the phrase of as a response to a first condition being satisfied comprises when the first condition is satisfied.

In one embodiment, the phrase of as a response to a first condition being satisfied comprises if the first condition is satisfied.

In one embodiment, the first RRC connection procedure failure comprises an RRC connection establishment failure.

In one embodiment, the first RRC connection procedure failure comprises an RRC connection recovery failure.

In one embodiment, the first RRC connection procedure comprises an SDT failure.

In one embodiment, the first RRC connection procedure failure comprises an RRC connection recovery failure, and the RRC connection recovery failure refers to an SDT failure.

In one embodiment, if the first condition is that the first timer expires and the first timer is the target timer, the first condition being satisfied indicates that the first timer expires and the first timer is the target timer.

In one embodiment, if the first condition is any condition in the first condition set, the first condition being satisfied refers to that any condition in the first condition set is satisfied.

In one embodiment, if the first RRC connection procedure is determined failed, the first timer is in an expired state, and the first condition is that the first timer expires.

In one embodiment, if the first RRC connection procedure is determined failed, the first timer is in an unexpired state, and the first condition is a condition in the first condition set and the first condition is not that the first timer expires.

As a response to determining the first RRC connection procedure failure, at least partial information in the first variant is cleared, and first failure information is stored in a first variant.

As a response to determining the first RRC connection procedure failure, all information in the first variant is cleared, and first failure information is stored in a first variant.

As a response to determining the first RRC connection procedure failure, all information other than a first counter in the first variant is cleared, and first failure information is stored in a first variant.

In one embodiment, when the first RRC connection procedure is determined failed, a cell identifier of the first cell is equal to a cell identifier stored in the first variant.

In one embodiment, when the first RRC connection procedure is determined failed, a cell identifier of the first cell is equal to a cell identifier in measResultFailedCell stored in the first variant.

In one embodiment, when the first RRC connection procedure is determined failed, the first variant does not comprise connection establishment failure information or connection recovery failure information, and an RPLMN is not equal to a plmn-identity stored in the first variant.

In one embodiment, when the first RRC connection procedure is determined failed, the first variant comprises connection establishment failure information or connection recovery failure information, and an RPLMN is not equal to a plmn-identity stored in the first variant.

In one embodiment, when the first RRC connection procedure is determined failed, the first variant does not comprise connection establishment failure information or connection recovery failure information, and an RPLMN is equal to a plmn-identity stored in the first variant.

In one embodiment, the first variant is used to store the first failure information.

In one embodiment, the first variant comprises a VarConnEstFailReport variant.

In one embodiment, the first variant comprises a VarRLF-Report variant.

In one embodiment, name of the first variant comprises VarConnEstFailReport or VarRLF-Report.

In one embodiment, name of the first variant does not comprise VarConnEstFailReport and VarRLF-Report.

In one embodiment, name of the first variant comprises at least one of Var or Report or SDT or IDT or small or data or transmission or INACTIVE or Conn or Est or Fail or failure.

In one embodiment, name of the first variant comprises at least one of SDT or IDT or small or data or transmission or INACTIVE or Conn or Est or Fail or failure.

In one embodiment, the first variant is used to store at least one of radio link failure information or handover failure information.

In one embodiment, the first variant is used to store at least one of connection establishment failure information or connection recovery failure information.

In one embodiment, the first variant is used to store SDT failure information.

In one embodiment, the first variant comprises an RRC field, and the RRC field indicates a PLMN-Identity.

In one embodiment, the first variant comprises an RRC field, and the RRC field indicates a ConnEstFailReport.

In one embodiment, the first variant comprises an RRC field, and the RRC field indicates a plmn-IdentityList.

In one embodiment, the first variant comprises an RRC field, and the RRC field indicates an RLF-Report.

In one embodiment, the behavior of storing first failure information in a first variant comprises: a field in the first variant is set according to the first failure information.

In one embodiment, the behavior of storing first failure information in a first variant comprises: a value of a field in the first variant is set as information corresponding to the first failure information.

In one embodiment, the non-RRC_CONNECTED State is not an RRC_CONNECTED State.

In one embodiment, the non-RRC_CONNECTED State comprises an RRC_INACTIVE State.

In one embodiment, the non-RRC_CONNECTED State comprises an RRC_IDLE State.

In one embodiment, the first variant comprises an RRC field, and the RRC field indicates the first measurement result.

In one embodiment, the first variant comprises an RRC field, and the RRC field is set as the first measurement result.

In one embodiment, measResultFailedCell in the first variant is set as a measurement result of an adjacent cell of the first cell.

In one embodiment, the first measurement result comprises at least one of a Global Cell Identity (GCI), or a Tracking Area Code (TAC), or cell-level RSRP, or cell-level RSRQ, or SS/PBCH block-level RSRP, or SS/PBCH block-level RSRQ, or SS/PBCH block index of the first cell.

In one embodiment, the first measurement result is a measurement result acquired after executing a measurement on an available SSB of the first cell.

In one embodiment, the first measurement result is a latest measurement result until the first RRC connection procedure is determined failed.

In one embodiment, the first variant comprises an RRC field, and the RRC field indicates a measurement result of an adjacent cell of the first cell.

In one embodiment, the first variant comprises an RRC field, and the RRC field is set as a measurement result of an adjacent cell of the first cell.

In one embodiment, a measurement result of an adjacent cell of the first cell comprises a measurement result of at least one cell.

In one embodiment, measResultNeighCells in the first variant is set as a measurement result of an adjacent cell of the first cell.

In one embodiment, the meaning of the phrase of whether the first failure information comprises first information being associated with the first condition comprises: the first condition is used to determine whether the first failure information comprises first information.

In one embodiment, the meaning of the phrase of whether the first failure information comprises first information being associated with the first condition comprises: whether the first failure information comprises first information is related to the first condition.

In one embodiment, the meaning of the phrase of whether the first failure information comprises first information being associated with the first condition comprises: the first condition is that the first timer expires and the first timer is a target timer, and the first failure information does not comprise the first information; or, the first condition is any condition in a first condition set, and the first failure information comprises the first information.

In one embodiment, the meaning of the phrase of whether the first failure information comprises first information being associated with the first condition comprises: the first condition is that the first timer expires and the first timer is a target timer, and the first failure information does not comprise the first information.

In one embodiment, the meaning of the phrase of whether the first failure information comprises first information being associated with the first condition comprises: the first condition is any condition in a first condition set, and the first failure information comprises the first information.

In on embodiment, the phrase of the first condition being that the first timer expires and the first timer being a target timer, and the first failure information not comprising first information comprises: the first condition of the first timer being expired and the first timer being the target timer is used to determine that the first failure information does not comprise the first information.

In on embodiment, the phrase of the first condition being that the first timer expires and the first timer being a target timer, and the first failure information not comprising first information comprises: if the first condition is that the first timer expires and the first timer is the target timer, the first failure information does not comprise the first information.

In on embodiment, the phrase of the first timer being expired and the first timer being the target timer refers to: T319 is expired or T300 is expired.

In on embodiment, the first timer being expired and the first timer being the target timer are used to determine a connection recovery failure or a connection establishment failure.

In on embodiment, the first timer being expired and the first timer being the target timer are used to determine a connection recovery failure, and the first timer is T319.

In on embodiment, the first timer being expired and the first timer being the target timer are used to determine a connection establishment failure, and the first timer is T300.

In one embodiment, the meaning of the phrase of the first failure information not comprising first information comprises: the first information is not information in the first failure information.

In one embodiment, the meaning of the phrase of the first failure information not comprising first information comprises: the first information is not stored in the first variant.

In one embodiment, the meaning of the phrase of the first failure information not comprising first information comprises: the first variant does not comprise the first information.

In one embodiment, the meaning of the phrase of the first failure information not comprising first information comprises: there does not exist an RRC field used to store the first information in the first variant.

In one embodiment, the meaning of the phrase of the first failure information not comprising first information comprises: there exists an RRC field used to store the first information in the first variant, while a value of the RRC field used to store the first information is not set.

In one embodiment, if the first condition comprises that the first timer expires, during a time interval between a time when the first timer is started and a time when the first timer expires, the first timer is not restarted.

In one subembodiment of the embodiment, a time interval between a time when the first timer expires and a time when the first timer is started is not less than an expiration value of the first timer.

In one embodiment, if the first condition comprises that the first timer expires, during a time interval between a time when the first timer is started and a time when the first timer expires, the first timer is restarted.

In one subembodiment of the embodiment, a time interval between a time when the first timer expires and a time when the first timer is last restarted is not less than an expiration value of the first timer.

In one embodiment, if the first condition comprises that the first timer expires, the first timer being expired refers to that a running time of the first timer reaches an expiration value of the first timer.

In one embodiment, if the first condition comprises that the first timer expires, the first timer being expired refers to that a timing of the first timer reaches an expiration value of the first timer.

In one embodiment, an expiration value of the first timer is configured through an RRC message.

In one embodiment, the phrase of the first condition being any condition in a first condition set, and the first failure information comprising first information comprises: if the first condition is any condition in the first condition set, the first failure information comprises the first information.

In one embodiment, the phrase of the first condition being any condition in a first condition set, and the first failure information comprising first information comprises: the first condition is that any condition in the first condition set is used to determine that the first failure information comprises the first information.

In one embodiment, the meaning of the phrase of the first failure information comprising first information comprises: the first information is information in the first failure information.

In one embodiment, the meaning of the phrase of the first failure information comprising first information comprises: the first information is stored in the first variant.

In one embodiment, the meaning of the phrase of the first failure information comprising first information comprises: the first variant comprises the first information.

In one embodiment, the meaning of the phrase of the first failure information comprising first information comprises: there exists an RRC field used to store the first information in the first variant.

In one embodiment, the meaning of the phrase of the first failure information comprising first information comprises: there exists an RRC field used to store the first information in the first variant, and a value of the RRC field used to store the first information is set.

In one embodiment, the first variant can be used to indicate the first information, and if the first condition is that the first timer expires and the first timer is a target timer, and the first information is not indicated in the first variant; if the first condition is any condition in the first condition set, the first information is indicated in the first variant.

In one embodiment, the first timer comprises the target timer.

In one embodiment, the first timer comprises T319.

In one embodiment, the first timer comprises T300.

In one embodiment, for the definition of the T319, refer to TS 38.331.

In one embodiment, for the definition of the T300, refer to TS 38.331.

In one embodiment, the first timer comprises a given timer, and the given timer is not the target timer.

In one embodiment, the first timer comprises a given timer, the given timer is not T319, and the given timer is not T300.

In one embodiment, the phrase of one condition in the first condition set being that the first timer expires and the first timer is a timer other than a target timer comprises: the first timer is a given timer, one condition in the first condition set is that the given timer expires, and the given timer is not the target timer.

In one embodiment, if the first RRC connection procedure is used for an SDT, the first timer is an RRC-layer timer.

In one embodiment, if the first RRC connection procedure is used for an SDT, the first timer is a MAC-layer timer.

In one embodiment, if the first RRC connection procedure is used for an SDT, the first timer is a lower-layer timer.

In one embodiment, if the first RRC connection procedure is not used for an SDT, the first timer is an RRC-layer timer.

In one embodiment, the target timer is an RRC-layer timer.

In one embodiment, the target timer comprises T319, and the target timer is used for an RRC connection resume procedure.

In one embodiment, the target timer comprises T300, and the target timer is used for an RRC connection establishment procedure.

In one embodiment, if the first RRC connection procedure is used for an RRC connection establishment, the target timer is T300.

In one embodiment, if the first RRC connection procedure is used for an RRC connection resume, the target timer is T319.

In one embodiment, the candidate message is used to determine ending the first RRC connection procedure.

In one embodiment, when the first timer is running, a candidate message is monitored.

In one subembodiment of the above embodiment, the candidate message comprises an RRC message.

In one subembodiment of the above embodiment, if the first message is an RRCSetupRequest message, the candidate message is any of an RRCSetup message or an RRCReject message.

In one subembodiment of the above embodiment, if the first message is an RRCResumeRequest message or an RRCResumeRequest1 message, the candidate message is any message of an RRCResume message or an RRCSetup message or an RRCRelease message or an RRCReject message.

In one subembodiment of the above embodiment, when the first timer is running, the candidate message is not received.

In one subembodiment of the above embodiment, within a time interval when the first timer is started and a time when the first timer expires, the candidate message is not received.

In one embodiment, the candidate message being received is used to determine stopping the first timer.

In one embodiment, the candidate message being received triggers the first timer stopping running.

In one embodiment, within the time interval between the first message is transmitted and the candidate message is received, a first-type sub-signaling is not transmitted.

In one embodiment, within the time interval between the first message is transmitted and the candidate message is received, at least one first-type sub-signaling is transmitted.

In one embodiment, when the first RRC connection failure procedure is determined failed, and if a target signaling is not received, name of the first variant comprises VarConnEstFailReport, if a target signaling is received, the first variant is a first candidate variant; herein, the first condition is any condition in the first condition set; the target signaling is a response for the first message.

In one subembodiment of the above embodiment, as a response to the first message being transmitted, the target signaling is monitored.

In one subembodiment of the above embodiment, the target signaling comprises a PDCCH scrambled by the first node in a C-RNTI of the first cell.

In one subembodiment of the above embodiment, the target signaling comprises a PDCCH scrambled by a TEMPORARY_C-RNTI.

In one subembodiment of the above embodiment, the target signaling comprises a PDCCH scrambled by an MSGB-RNTI.

In one subembodiment of the above embodiment, the target signaling comprises a UE Contention Resolution Identity MAC CE.

In one subembodiment of the above embodiment, the target signaling comprises a successRAR MAC subPDU.

In one subembodiment of the above embodiment, the target signaling is a first downlink signaling received after the first message is transmitted.

In one subembodiment of the above embodiment, the target signaling is a first downlink physical-layer signaling received after the first message is transmitted.

In one subembodiment of the above embodiment, the target signaling is a first downlink MAC-layer signaling received after the first message is transmitted.

In one embodiment, as a response to receiving a target signaling, a first-type sub-message is transmitted.

In one embodiment, as a response to receiving a first-type sub-signaling, a first-type sub-message is transmitted.

In one embodiment, accompanying the target signaling, the first timer is restarted.

In one embodiment, accompanying the target signaling, the first timer is not restarted.

In one embodiment, accompanying a first-type sub-signaling, the first timer is restarted.

In one embodiment, accompanying a first-type sub-signaling, the first timer is not restarted.

In one embodiment, accompanying a first-type sub-message, the first timer is restarted.

In one embodiment, accompanying a first-type sub-message, the first timer is not restarted.

In one embodiment, restarting the first timer refers to the first timer restarting timing.

In one embodiment, the target signaling is a first first-type sub-signaling.

In one embodiment, the candidate message is a last first-type sub-signaling.

In one embodiment, the target signaling is the same as the candidate message.

In one embodiment, the target signaling is the different from the candidate message.

In one embodiment, a first-type sub-signaling is a downlink signaling, and a first-type sub-message is an uplink signaling.

In one embodiment, the first-type sub-signaling and the first-type sub-message belongs to the first RRC connection procedure.

In one embodiment, the first-type sub-message is a response for the first-type sub-signaling.

In one embodiment, the first-type sub-signaling comprises the target signaling.

In one embodiment, the first-type sub-signaling is a downlink signaling after the target signaling.

In one embodiment, the first-type sub-signaling comprises a DCI.

In one embodiment, the first-type sub-signaling is used to schedule a PUSCH.

In one embodiment, the first-type sub-signaling comprises DownLink Control Information (DCI).

In one embodiment, as a response to the behavior of transmitting a first-type sub-message, a PDCCH scrambled by a C-RNTI is monitored.

In one embodiment, as a response to the behavior of transmitting a first-type sub-message, another first-type sub-message is received.

In one embodiment, within a time interval from when the first message is transmitted to the first RRC connection procedure is determined failed, at least one first-type sub-message is transmitted.

In one embodiment, within a time interval from when the first message is transmitted to the first RRC connection procedure is determined failed, any first-type sub-message is not transmitted.

In one embodiment, the first-type sub-signaling comprises the candidate message.

In one embodiment, the candidate message is a last first-type sub-signaling.

In one embodiment, the target signaling is a first-type sub-signaling in the first RRC connection procedure.

In one embodiment, the target signaling is a first first-type sub-signaling in the first RRC connection procedure.

In one embodiment, the first-type sub-message is transmitted through a DRB.

In one embodiment, the first-type sub-message is transmitted through a UL-SCH.

In one embodiment, the first-type sub-message is transmitted through an SL-SCH.

In one embodiment, a first message is transmitted on a first cell, the first message is used to request a first RRC connection procedure; accompanying the first message, a first timer is started; as a response to a first condition being satisfied, the first RRC connection procedure failure is determined; as a response to determining that the first RRC connection procedure fails, first failure information is stored in a first variant; when the first message is transmitted, the first node is not in an RRC_CONNECTED State; the first failure information comprises a first measurement result, and the first measurement result is associated with the first cell; whether the first failure information comprises first information is associated with the first condition.

In one subembodiment of the embodiment, the first message is an RRCSetupRequest message, the non-RRC_CONNECTED State is an RRC_IDLE State, the first condition is that the first timer expires and the first timer is a target timer, the first failure information does not comprise the first information, and the target timer is T300.

In one subembodiment of the embodiment, the first message is an RRCResumeRequest message or an RRCResumeRequest1 message, the non-RRC_CONNECTED State is an RRC-INACTIVE state, the first condition is that the first timer expires and the first timer is a target timer, the first failure information does not comprise the first information, and the target timer is T319.

In one subembodiment of the embodiment, the first message is an RRCResumeRequest message or an RRCResumeRequest1 message, the non-RRC_CONNECTED State is an RRC-INACTIVE state, the first condition is any condition in the first condition set, the first failure information comprises the first information, any condition in the first condition set is that the first timer expires and the first timer is a timer other than a target timer, the target timer is T319, or the target timer is T300.

In one embodiment, for the convenience of expression, names of RRC IE or RRC field in the present application does not comprise version number, in the specific implementation of the patent, names of RRC IE or RRC field in the present application can also comprise protocol version number to achieve the same technical effects. For example, daps-Config field can be daps-Config-r16 field, or daps-Config-r17 field; CondReconfigId IE can be CondReconfigId-r16 IE, or CondReconfigId-r17 IE.

In one embodiment, for the convenience of expression, names of RRC IE or RRC field in the present application comprises uppercase or lowercase letters, in the specific implementation of the patent, names of RRC IE or RRC field in the present application can be any combination of uppercase or lowercase to achieve similar technical effects. For example, drb-Identity can be Drb-Identity; Daps-Config can be DAPS-Config, or daps-Config.

### Embodiment 2

Embodiment 2 illustrates a schematic diagram of a network architecture according to one embodiment of the present application, as shown in FIG. 2. FIG. 2 is a diagram illustrating a network architecture 200 of 5G NR, Long-Term Evolution (LTE) and Long-Term Evolution Advanced (LTE-A) systems. The 5G NR/LTE/LTE-A network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The RAN comprises the node 203 and other nodes 204. The node 203 provides UE 201-oriented user plane and control plane protocol terminations. The node 203 may be connected to other nodes 204 via an Xn interface (e. g., backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is a UE.

In one embodiment, the node 203 corresponds to the second node in the present application.

In one embodiment, the node 203 corresponds to the third node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is a ng-eNB.

In one embodiment, the node 203 is an en-gNB.

In one embodiment, the node 203 is a UE.

In one embodiment, the node 203 is a relay.

In one embodiment, the node 203 is a gateway.

In one embodiment, the UE supports Terrestrial Network (NTN) transmission.

In one embodiment, the UE supports Non-Terrestrial Network (NTN) transmission.

In one embodiment, the UE supports communications within networks with large latency differences.

In one embodiment, the UE supports Dual Connection (DC) transmission.

In one embodiment, the UE comprises an aircraft.

In one embodiment, the UE comprises a vehicle terminal.

In one embodiment, the UE comprises a vessel.

In one embodiment, the UE comprises an Internet of Things (IoT) terminal.

In one embodiment, the UE comprises an industrial Internet of Things (IoT) terminal.

In one embodiment, the UE comprises a device supporting transmission with low-latency and high-reliability.

In one embodiment, the UE comprises a test equipment.

In one embodiment, the UE comprises a signaling tester.

In one embodiment, the base station supports transmission over NTNs.

In one embodiment, the base station supports transmission over networks with large latency differences.

In one embodiment, the base station supports transmission over TNs.

In one embodiment, the base station comprises a Marco Cellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station supporting large latency differences.

In one embodiment, the base station comprises a flight platform equipment.

In one embodiment, the base station comprises a satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises a test equipment.

In one embodiment, the base station comprises a signaling tester.

In one embodiment, the base station comprises an Integrated Access and Backhaul (IAB)-node.

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises an L3 relay.

In one embodiment, the relay comprises an L2 relay.

In one embodiment, the relay comprises a router.

In one embodiment, the relay comprises a switch.

In one embodiment, the relay comprises a UE.

In one embodiment, the relay comprises a base station.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 is represented by three layers, which are a layer 1, a layer 2 and a layer 3, respectively. The layer 1 (L1) is the lowest layer and performs signal processing functions of various PHY layers. The L1 is called PHY 301 in the present application. L2 305, above the PHY 301, comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variant radio bearers and logical channels. The PDCP sublayer 304 provides security by encrypting a data packet and provides support for handover. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating various radio resources (i.e., resources block) in a cell. The MAC sublayer 302 is also in charge of HARQ operation. The RRC sublayer 306 in L3 layer of the control plane 300 is responsible for acquiring radio resources (i.e., radio bearer) and configuring the lower layer with an RRC signaling. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic.

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the first message in the present application is generated by the RRC 306.

In one embodiment, the first message in the present application is generated by the MAC 302 or the MAC 352.

In one embodiment, the first message in the present application is generated by the PHY 301 or the PHY 351.

In one embodiment, the second message in the present application is generated by the RRC 306.

In one embodiment, the second message in the present application is generated by the MAC 302 or the MAC 352.

In one embodiment, the second message in the present application is generated by the PHY 301 or the PHY 351.

### Embodiment 4

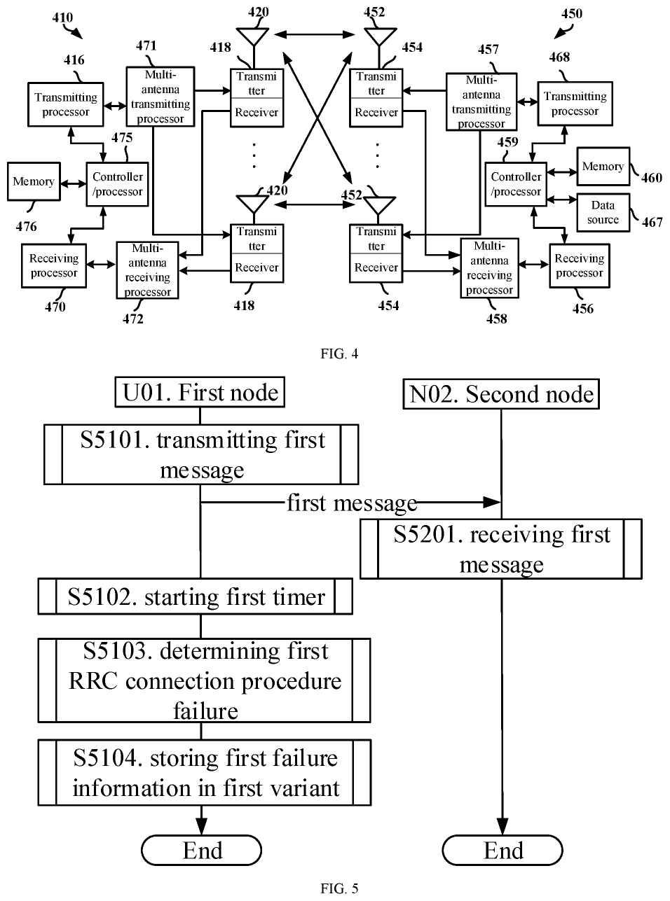

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory. at least one processor and at least one memory. The at least one memory comprises computer program codes; the at least one memory and the computer program codes are configured to be used in collaboration with the at least one processor, the first communication device 450 at least transmits a first message on a first cell, the first message is used to request a first RRC connection procedure; accompanying the first message, starts a first timer; as a response to a first condition being satisfied, determines the first RRC connection procedure failure; as a response to determining the first RRC connection procedure failure, stores first failure information in a first variant; herein, when the first message is transmitted, the first node is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T319, or the target timer is T300.

In one embodiment, the first communication device 450 comprises at least one processor and at least one memory. a memory that stores a computer readable instruction program. The computer readable instruction program generates an action when executed by at least one processor. The action includes: transmitting a first message on a first cell, the first message being used to request a first RRC connection procedure; accompanying the first message, starting a first timer; as a response to a first condition being satisfied, determining the first RRC connection procedure failure; as a response to determining the first RRC connection procedure failure, storing first failure information in a first variant; herein, when the first message is transmitted, the first node is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T319, or the target timer is T300.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: receives a first message on a first cell, the first message is used to request a first RRC connection procedure; herein, accompanying the first message, a first timer is started; as a response to a first condition being satisfied, the first RRC connection procedure is determined to be failed; as a response to that the first RRC connection procedure is determined to be failed, first failure information is stored in a first variant; when the first message is transmitted, a transmitter of the first message is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T319, or the target timer is T300.

In one embodiment, the second communication device 410 comprises a memory that stores a computer readable instruction program. The computer readable instruction program generates an action when executed by at least one processor. The action includes: receiving a first message on a first cell, the first message being used to request a first RRC connection procedure; herein, accompanying the first message, a first timer is started; as a response to a first condition being satisfied, the first RRC connection procedure is determined to be failed; as a response to that the first RRC connection procedure is determined to be failed, first failure information is stored in a first variant; when the first message is transmitted, a transmitter of the first message is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T319, or the target timer is T300.

In one embodiment, the antenna 452, the receiver 454, the receiving processor 456, and the controller/processor 459 are used to receive a first message; at least one of the antenna 420, the transmitter 418, the transmitting processor 416, or the controller/processor 475 is used to transmit a first message.

In one embodiment, the antenna 452, the receiver 454, the receiving processor 456, the controller/processor 459 are used to receive a second message; at least one of the antenna 420, the transmitter 418, the transmitting processor 416, or the controller/processor 475 is used to transmit the second message.

In one embodiment, the first communication device 450 corresponds to a first node in the present application.

In one embodiment, the second communication device 410 corresponds to a second node in the present application.

In one embodiment, the second communication device 410 corresponds to a third node in the present application.

In one embodiment, the first communication device 450 is a UE.

In one embodiment, the first communication device 450 is a UE that supports large delay differences.

In one embodiment, the first communication device 450 is a UE that supports NTNs.

In one embodiment, the first communication device 450 is an aircraft device.

In one embodiment, the first communication device 450 has a positioning capability.

In one embodiment, the first communication device 450 does not have a positioning capability.

In one embodiment, the first communication device 450 is a UE that supports TNs.

In one embodiment, the second communication device 410 is a base station (gNB/eNB/ng-eNB).

In one embodiment, the second communication device 410 is a base station that supports large delay differences.

In one embodiment, the second communication device 410 is a base station that supports NTN.

In one embodiment, the second communication device 410 is a satellite equipment.

In one embodiment, the second communication device 410 is flying platform equipment.

In one embodiment, the second communication device 410 is a base station that supports TNs.

### Embodiment 5

Embodiment 5 illustrates a flowchart of radio signal transmission according to one embodiment in the present application, as shown in FIG. 5. It is particularly underlined that the order illustrated in the embodiment does not put constraints over sequences of signal transmissions and implementations.

The first node U01, in step S5101, transmits a first message on a first cell, the first message is used to request a first RRC connection procedure; in step S5102, accompanying the first message, starts a first timer; in step S5103, as a response to a first condition being satisfied, determines the first RRC connection procedure failure; in step S5104, as a response to determining the first RRC connection procedure failure, stores first failure information in a first variant.

The second node N02, in step S5201, receives the first message.

In embodiment 5, when the first message is transmitted, the first node U01 is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprises the first information; or, the first condition is any condition in a first condition set, and the first failure information comprises the first information; one condition in the first condition set is that the first timer expires and the first timer is a timer other than a target timer; the target timer is T319, or the target timer is T300.

In one embodiment, the first node U01 is a UE.

In one embodiment, the first node U01 is a test equipment.

In one embodiment, the first node U01 is an IoT device.

In one embodiment, the second node N02 is a maintenance base station of the first cell.

In one embodiment, the second node N02 is a base station.

In one embodiment, the second node N02 is a relay device.

In one embodiment, if the first condition is that the first timer expires and the first timer is the target timer, name of the first variant comprises VarConnEstFailReport; if the first condition is any condition in a first condition set, name of the first variant comprises VarConnEstFailReport.

In one embodiment, if the first condition is that the first timer expires and the first timer is the target timer, name of the first variant comprises VarConnEstFailReport; if the first condition is any condition in a first condition set, and the first variant is the first candidate variant.

In one embodiment, the first message is an RRCSetupRequest message, the non-RRC_CONNECTED State is RRC_IDLE State, the first condition is that the first timer expires and the first timer is a target timer, the first failure information does not comprise the first information, and the target timer is T300, the first variant is associated with that the first timer expires and the first timer is the target timer, and name of the first variant comprises VarConnEstFailReport; or, the first message is an RRCResumeRequest message or an RRCResumeRequest1 message, the non-RRC_CONNECTED State is RRC_INACTIVE state, the first condition is that the first timer expires and the first timer is a target timer, the first failure information does not comprise the first information, the target timer is T319, the first variant is associated with that the first timer expires and the first timer is the target timer, and name of the first variant comprises VarConnEstFailReport; or, the first message is an RRCResumeRequest message or an RRCResumeRequest1 message, the non-RRC_CONNECTED State is RRC_INACTIVE state, the first condition is any condition in the first condition set, the first failure information comprises the first information, any condition in the first condition set is that the first timer expires and the first timer is a timer other than a target timer, the target timer is T319, or the target timer is T300, the first variant is associated with the first timer being expired and the first timer is the target timer, and name of the first variant comprises VarConnEstFailReport.

In one embodiment, the first message is an RRCSetupRequest message, the non-RRC_CONNECTED State is RRC_IDLE State, the first condition is that the first timer expires and the first timer is a target timer, the first failure information does not comprise the first information, and the target timer is T300, the first variant is associated with that the first timer expires and the first timer is the target timer, and name of the first variant comprises VarConnEstFailReport; or, the first message is an RRCResumeRequest message or an RRCResumeRequest1 message, the non-RRC_CONNECTED State is RRC INACTIVE state, the first condition is that the first timer expires and the first timer is a target timer, the first failure information does not comprise the first information, the target timer is T319, the first variant is associated with that the first timer expires and the first timer is the target timer, and name of the first variant comprises VarConnEstFailReport; or, the first message is an RRCResumeRequest message or an RRCResumeRequest1 message, the non-RRC_CONNECTED State is RRC-INACTIVE state, the first condition is any condition in the first condition set, the first failure information comprises the first information, any condition in the first condition set is that the first timer expires and the first timer is a timer other than a target timer, the target timer is T319, or the target timer is T300, the first variant is a first candidate variant.

In one embodiment, the first variant is associated with that the first timer expires and the first timer is the target timer, and name of the first variant comprises VarConnEstFailReport.

In one embodiment, the meaning of the phrase of the first variant being associated with the first timer being expired and the first timer being the target timer, and name of the first variant comprising VarConnEstFailReport comprises: whether the first condition is that the first timer expires and the first timer is a target timer, or the first condition is any condition in the first condition set, the first variant is associated with that the first timer expires and the first timer is the target timer, and name of the first variant comprises VarConnEstFailReport.

In one embodiment, the meaning of the phrase of the first variant being associated with the first timer being expired and the first timer being the target timer, and name of the first variant comprising VarConnEstFailReport comprises: the first variant is a VarConnEstFailReport.

In one embodiment, the meaning of the phrase of the first variant being associated with the first timer being expired and the first timer being the target timer, and name of the first variant comprising VarConnEstFailReport comprises: name of the first variant comprises VarConnEstFailReport, and the first variant is a variant used to store at least one of connection recovery failure information or connection establishment failure information when the first timer expires and the first timer is the target timer.

In one embodiment, the meaning of the phrase of the first variant being associated with the first timer being expired and the first timer being the target timer, and name of the first variant comprising VarConnEstFailReport comprises: name of the first variant comprises VarConnEstFailReport.

In one embodiment, the meaning of the phrase of the first variant being associated with the first timer being expired and the first timer being the target timer, and name of the first variant comprising VarConnEstFailReport comprises: when the first condition is any condition in the first condition set, the first failure information is stored in the first variant, and name of the first variant comprises VarConnEstFailReport.

In one embodiment, the first condition is any condition in the first condition set, and the first variant is a first candidate variant.

In one embodiment, name of the first candidate variant do not comprise VarConnEstFailReport.

In one embodiment, the first candidate variant is VarRLF-Report.

In one embodiment, the first candidate variant is a variant other than VarConnEstFailReport and VarRLF-Report.

In one embodiment, the first candidate variant is not VarConnEstFailReport

In one embodiment, the first candidate variant is not VarConnEstFailReport or VarRLF-Report.

In one embodiment, name of the first candidate variant comprises at least one of Var or sdt or idt or small or inactive or data or transmission or trans or failure or fail or Report.

In one embodiment, the phrase of the first condition being any condition in the first condition set, and the first variant being a first candidate variant comprises: if the first condition is any condition in the first condition set, the first variant is a first candidate variant.

In one embodiment, the phrase of the first condition being any condition in the first condition set, and the first variant being a first candidate variant comprises: only when the first condition is any condition in the first condition set, the first variant is a first candidate variant.

In one embodiment, conditions in the first condition set also comprise at least one of a maximum number of RLC retransmissions having been reached, or timer T310 being expired, or occurring LBT failure, or occurring BFR failure, or occurring random access failure.

In one embodiment, the occurring a BFR failure refers to: a random access problem occurs, and the random access is used for beam failure recovery.

In one embodiment, the occurring a random access failure comprises: receiving a random access problem indication of a MAC of the first cell.

In one embodiment, the occurring a random access failure comprises: receiving a random access problem indication of a MAC of a cell group to which the first cell belongs.

In one embodiment, the RLC retransmissions reaching a maximum value comprises: receiving an indication that a maximum number of RLC retransmissions of the first cell has been reached.

In one embodiment, the maximum number of RLC retransmissions having been reached comprises: receiving an indication that a maximum number of RLC retransmissions from a cell group to which the first cell belongs has been reached.

In one embodiment, the occurring an LBT failure refers to: receiving an indication of continuous uplink LBT failures from a MAC of the first cell.

In one embodiment, the occurring an LBT failure refers to: receiving an indication of continuous uplink LBT failures from a MAC of a cell group to which the first cell belongs.

In one embodiment, the first node receives an indication of a MAC layer at an RRC layer, and the indication is used to determine the occurrence of a BFR failure.

In one embodiment, the first node receives an indication of a MAC layer at an RRC layer, and the indication is used to determine the occurrence of an LBT failure.

In one embodiment, the first node receives an indication of a MAC layer at an RRC layer, and the indication is used to determine the occurrence of a random access problem.

In one embodiment, the first node receives an indication of an RLC layer at an RRC layer, and the indication is used to determine that a maximum number of the RLC retransmissions has been reached.

In one embodiment, the timer T310 reaching an expiration value of the timer T310 is used to determine that the timer T310 expires.

In one embodiment, the timer T310 being expired refers to: a timer T310 of the first cell expires.

In one embodiment, for definition of the timer T310, refer to 3GPP TS38.331.

In one embodiment, for definition of the timer T310, refer to 3GPP TS36.331.

In one embodiment, for definition of LBT failure, refer to 3GPP TS38.321.

In one embodiment, for definition of BFR failure, refer to 3GPP TS38.321.

In one embodiment, the timer T310 belongs to the first cell.

In one embodiment, the step S5101 is taken before the step S5102.

In one embodiment, the step S5101 is taken after the step S5102.

### Embodiment 6

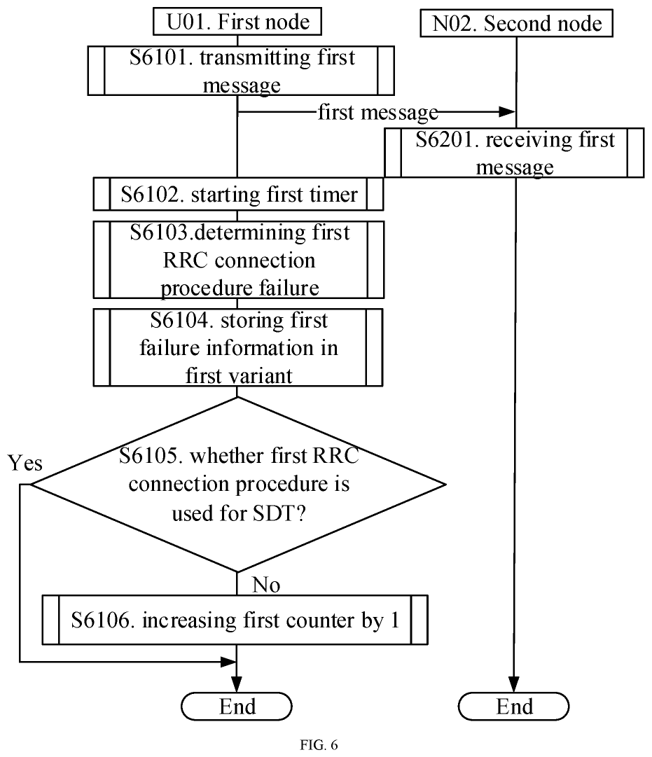

Embodiment 6 illustrates a flowchart of radio signal transmission according to another embodiment of the present application, as shown in FIG. 6. It is particularly underlined that the order illustrated in the embodiment does not put constraints over sequences of signal transmissions and implementations.

The first node U01, in step S6101, transmits a first message on a first cell, the first message is used to request a first RRC connection procedure; in step S6102, accompanying the first message, starts a first timer; in step S6103, as a response to a first condition being satisfied, determines the first RRC connection procedure failure; in step S6104, as a response to determining that the first RRC connection procedure fails, stores first failure information in a first variant; in step S6105, as a response to determining the first RRC connection procedure failure, judges whether the first RRC connection procedure is used for an SDT, and determines whether a first counter is increased by 1 according to whether the first RRC connection procedure is used for an SDT; if the first RRC connection procedure is not used for an SDT, enters into step S6106, and if the first RRC connection procedure is used for an SDT, skips the step S6106; in step S6106, increases the first counter by 1.

The second node N02, in step S6201, receives the first message.

In embodiment 6, when the first message is transmitted, the first node U01 is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T319, or the target timer is T300; the first variant comprises the first counter; the behavior of whether the first counter is increased by 1 according to whether the first RRC connection procedure is used for an SDT comprises: if the first RRC connection procedure is not used for an SDT, increasing the first counter by 1; if the first RRC connection procedure is used for an SDT, not increasing the first counter by 1.

In one embodiment, the behavior of determining whether a first counter is increased by 1 according to whether the first RRC connection procedure is used for an SDT comprises: whether the first counter is increased by 1 is related to at least whether the first RRC connection procedure is used for an SDT.

In one embodiment, the behavior of determining whether a first counter is increased by 1 according to whether the first RRC connection procedure is used for an SDT comprises: whether the first counter is increased by 1 is related to whether the first RRC connection procedure is used for an SDT.

In one embodiment, the behavior of determining whether a first counter is increased by 1 according to whether the first RRC connection procedure is used for an SDT comprises: at least whether the first RRC connection procedure is used for an SDT is used to determine whether the first counter is increased by 1.

In one embodiment, the behavior of determining whether a first counter is increased by 1 according to whether the first RRC connection procedure is used for an SDT comprises: whether the first RRC connection procedure is used for an SDT is used to determine whether the first counter is increased by 1.

In one embodiment, the first counter is numberOfConnFail.

In one embodiment, the first counter is used to determine times of RRC connection failure or RRC connection resume failure.

In one embodiment, the phrase of if the first RRC connection procedure is not used for an SDT comprises if the first condition is that the first timer expires and the first timer is the target timer.

In one embodiment, the phrase of if the first RRC connection procedure is used for an SDT comprises if the first condition is any condition in a first condition set.

In one embodiment, if the first condition is that the first timer expires and the first timer is the target timer, the first counter is increased by 1; if the first condition is any condition in a first condition set, the first counter is not increased by 1.

In one embodiment, “the first variant being a first candidate variant” is used to determine “not increasing the first counter by 1”.

In one embodiment, “name of the first variant comprising VarConnEstFailReport” is used to determine “increasing the first counter by 1”.

In one embodiment, the step S6101 is taken before the step S6102.

In one embodiment, the step S6101 is taken after the step S6102.

### Embodiment 7

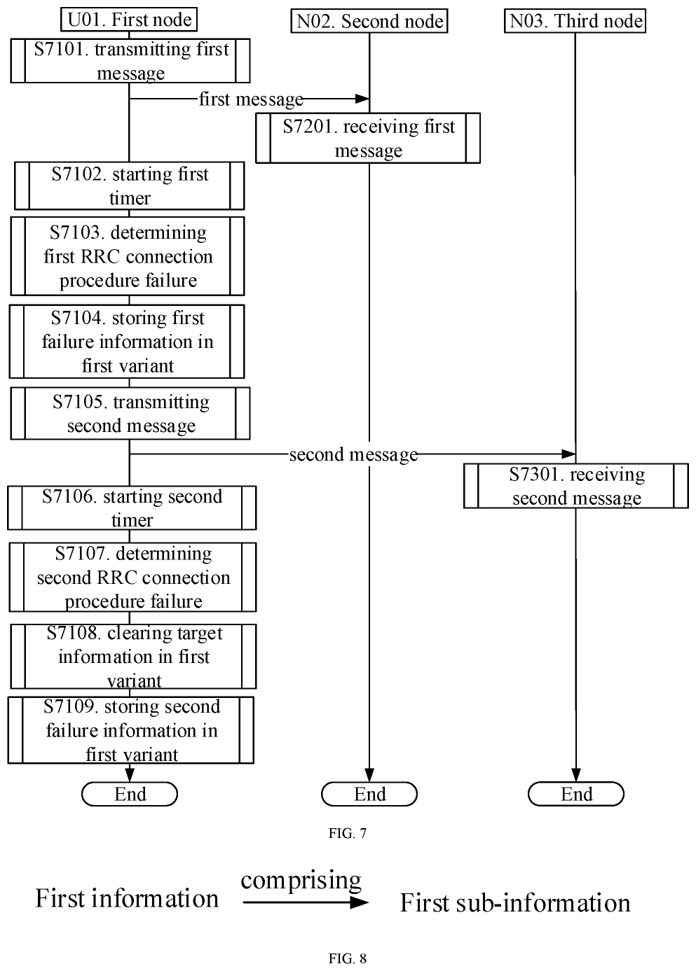

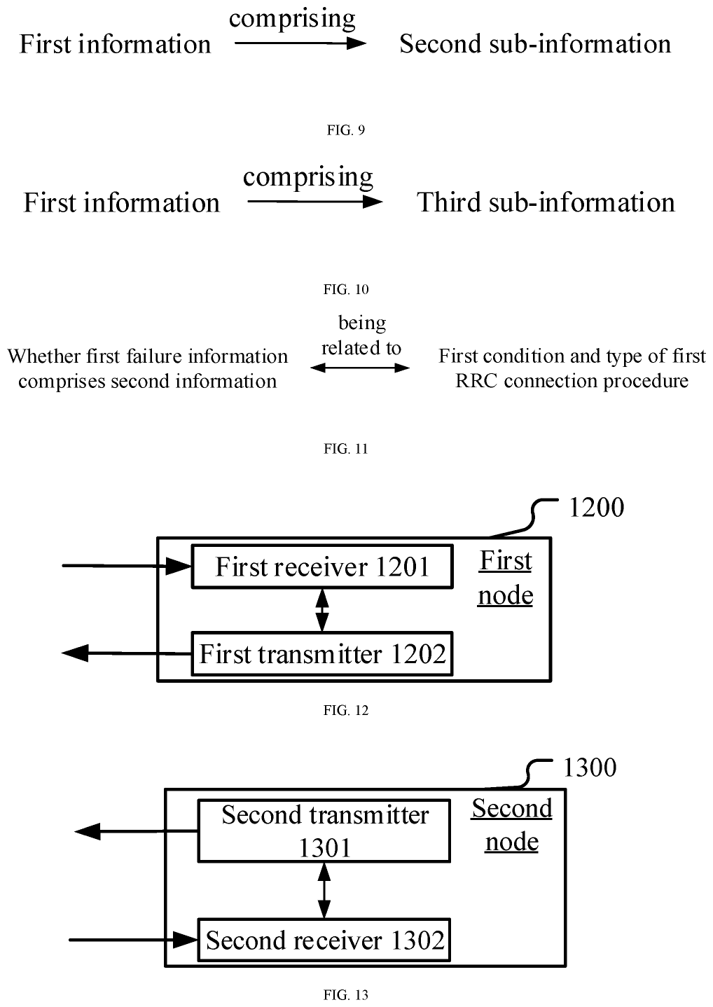

Embodiment 7 illustrates a flowchart of radio signal transmission according to another embodiment in the present application, as shown in FIG. 7. It is particularly underlined that the order illustrated in the embodiment does not put constraints over sequences of signal transmissions and implementations.

The first node U01, in step S7101, transmits a first message on a first cell, the first message is used to request a first RRC connection procedure; in step S7102, accompanying the first message, starts a first timer; in step S7103, as a response to a first condition being satisfied, determines the first RRC connection procedure failure; in step S7104, as a response to determining the first RRC connection procedure failure, stores first failure information in a first variant; in step S7105, after the first RRC connection procedure is determined failed, transmits a second message on a second cell, the second message being used to request a second RRC connection procedure; in step S7106, accompanying the second message, starts a second timer; in step S7107, as a response to the second timer being expired, determines the second RRC connection procedure failure; in step S7108, as a response to determining the second RRC connection procedure failure, clears target information in the first variant; in step S7109, as a response to determining the second RRC connection procedure failure, stores second failure information in the first variant.

The second node N02 receives the first message in step S7201.

The third node N03 receives the second message in step S7301.

In embodiment 7, when the first message is transmitted, the first node U01 is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprises the first information; or, the first condition is any condition in a first condition set, and the first failure information comprises the first information; one condition in the first condition set is that the first timer expires and the first timer is a timer other than a target timer; the target timer is T319, or the target timer is T300; the second failure information comprises a second measurement result, and the second measurement result is associated with the second cell; the target information does not comprise at least partial information in the first failure information.

In one embodiment, the second node N02 is different from the third node N03.

In one embodiment, the second node N02 is different from the third node N03.

In one embodiment, the third node N03 is a maintenance base station of the second cell.

In one embodiment, the third node N03 is a base station.

In one embodiment, the third node N03 is a relay device.

In one embodiment, the second cell is the same as the first cell.

In one embodiment, the second cell is different from the first cell.

In one embodiment, the second message comprises an RRCResumeRequest message.

In one embodiment, the second message comprises an RRCResumeRequest1 message.

In one embodiment, the second message comprises an RRCSetupRequest message.

In one embodiment, the second RRC connection procedure is used for an RRC connection resume procedure.

In one embodiment, the second RRC connection procedure is used for an RRC connection establishment procedure.

In one embodiment, the second RRC connection procedure is used for an RRC connection resume procedure.

In one embodiment, the second RRC connection procedure is an RRC connection establishment procedure.

In one embodiment, before the second message is set, the second timer is started.

In one embodiment, before the second message is transmitted, the second timer is started.

In one embodiment, before initiating a transmission procedure of the second message, the second timer is started.

In one embodiment, the second timer is an RRC-layer timer.

In one embodiment, the second timer is one of T319 or T300.

In one embodiment, the second timer being expired is used to determine the second RRC connection procedure failure.

In one embodiment, the second RRC connection procedure failure comprises that the second timer expires.

In one embodiment, the second timer being expired triggers the second RRC connection procedure failure.

In one embodiment, as a response to determining the second RRC connection procedure failure, the first timer is not cleared.

In one embodiment, the first failure information does not comprise the first counter.

In one embodiment, first the target information in the first variant is cleared, then the second failure information is stored in the first variant.

In one embodiment, the meaning of the behavior of clearing target information in the first variant comprises: clearing contents other than the at least partial information in the first failure information in the first variant.

In one embodiment, the meaning of the behavior of clearing target information in the first variant comprises: at least partial information in the first failure information in the first variant is not cleared.

In one embodiment, the meaning of the behavior of clearing target information in the first variant comprises: at least part of the first failure information in the first variant is not cleared.

In one embodiment, the meaning of the behavior of clearing target information in the first variant comprises: all of the first failure information in the first variant is not cleared.

In one embodiment, the first variant comprises an RRC field, and the RRC field indicates the second measurement result.

In one embodiment, the first variant comprises an RRC field, and the RRC field is set as the second measurement result.

In one embodiment, measResultFailedCell in the first variant is set as a measurement result of an adjacent cell of the second cell.

In one embodiment, the second measurement result comprises at least one of a Global Cell Identity (GCI), or a Tracking Area Code (TAC), or cell-level Reference Signal Received Power (RSRP), or cell-level Reference Signal Received Quality (RSRQ), or SS/PBCH block-level RSRP, or Synchronization Signal (SS)/Physical Broadcast Channel (PBCH) block-level RSRQ, or SS/PBCH block index of the second cell.

In one embodiment, the second measurement result is a measurement result acquired by executing a measurement on an available Synchronization Signal Block (SSB) of the second cell.

In one embodiment, the second measurement result is a latest measurement result until the second RRC connection procedure is determined failed.

In one embodiment, the first variant comprises an RRC field, and the RRC field indicates a measurement result of an adjacent cell of the second cell.

In one embodiment, the first variant comprises an RRC field, and the RRC field is set as a measurement result of an adjacent cell of the second cell.

In one embodiment, a measurement result of an adjacent cell of the second cell comprises a measurement result of at least one cell.

In one embodiment, measResultNeighCells in the first variant is set as a measurement result of an adjacent cell of the second cell.

In one embodiment, the at least partial information in the first failure information comprises numberOfConnFail.

In one embodiment, the at least partial information in the first failure information comprises the first sub-information.

In one embodiment, the at least partial information in the first failure information comprises the second sub-information.

In one embodiment, the at least partial information in the first failure information comprises the third sub-information.

In one embodiment, the at least partial information in the first failure information comprises the first measurement result.

In one embodiment, the at least partial information in the first failure information comprises at least one of the first measurement result, or the first sub-information, or the second sub-information, or the third sub-information.

In one embodiment, if there exists connection establishment failure information or connection resume failure information in the first variant, and the connection failure information or the connection resume failure information is triggered by T300 expiration or T319 expiration, and as a response to determining the second RRC connection procedure failure, contents other than the first counter in the first variant are cleared.

In one embodiment, the second message is an RRCResumeRequest message or an RRCResumeRequest1 message; the second RRC connection procedure is used for an RRC connection resume, and the first node is in an RRC_INACTIVE state when the second message is transmitted; the second timer is T319; the second RRC connection procedure failure refers to an RRC connection resume failure; the first condition is any condition in the first condition set; name of the first variant comprises VarConnEstFailReport.

In one embodiment, the second message is an RRCSetupRequest message; the second RRC connection procedure is used for an RRC connection establishment, and the first node is in an RRC_IDLE state when the second message is transmitted; the second timer is T300; the second RRC connection procedure failure refers to an RRC connection establishment failure; the first condition is any condition in the first condition set; name of the first variant comprises VarConnEstFailReport.

In one embodiment, the step S7101 is taken before the step S7102.

In one embodiment, the step S7101 is taken after the step S7102.

In one embodiment, the step S7105 is taken before the step S7106.

In one embodiment, the step S7105 is taken after the step S7106.

### Embodiment 8

Embodiment 8 illustrates a schematic diagram of first information comprising first sub-information according to one embodiment of the present disclosure.

In embodiment 8, the first information comprises first sub-information, and the first sub-information is used to indicate the first condition.

In one embodiment, if the first condition is that the first timer expires and the first timer is a timer other than a target timer, the first sub-information indicates that the first timer expires.

In one embodiment, if the first condition is that RLC retransmissions have reached a maximum number, the first sub-information indicates that RLC retransmissions have reached a maximum number.

In one embodiment, if the first condition is that timer T310 expires, the first sub-information indicates that timer T310 expires.

In one embodiment, if the first condition is that LBT failure occurs, the first sub-information indicates that LBT failure occurs.

In one embodiment, if the first condition is that BFR failure occurs, the first sub-information indicates that BFR failure occurs.

In one embodiment, if the first condition is that a random access failure occurs, the first sub-information indicates that a random access failure occurs.

In one embodiment, if the first condition is that BFR failure occurs, first sub-information comprises: beamFailureRecovery.

In one embodiment, if the first condition is that timer T310 expires, first sub-information comprises: t310-Expiry.

In one embodiment, if the first condition is that a random access failure occurs, first sub-information comprises: randomAccessProblem.

In one embodiment, if the first condition is that RLC retransmissions have reached a maximum number, first sub-information comprises: rlc-MaxNumRetx.

In one embodiment, if the first condition is that LBT failure occurs, first sub-information comprises: lbtFailure.

In one embodiment, the first variant comprises an RRC field, and the RRC field indicates the first sub-information.

In one embodiment, the behavior of storing first failure information in a first variant comprises: an RRC field in the first variant is set as the first sub-information.

### Embodiment 9

Embodiment 9 illustrates a schematic diagram of first information comprising second sub-information according to one embodiment of the present disclosure.

In embodiment 9, the first information comprises second sub-information, and the second sub-information is used to determine whether a type of the first RRC connection procedure is a first type or a second type; if the type of the first RRC connection procedure is the first type, the first message is transmitted in a random access procedure; and if the type of the first RRC connection procedure is the second type, the first message is transmitted on pre-configured uplink resources.

In one embodiment, the phrase of the second sub-information being used to determine whether the type of the first RRC connection procedure is a first type or a second type comprises: the second sub-information indicates whether the type of the first RRC connection procedure is the first type or the second type.

In one embodiment, the phrase of the second sub-information being used to determine whether the type of the first RRC connection procedure is a first type or a second type comprises: the second sub-information explicitly indicates whether the type of the first RRC connection procedure is the first type or the second type.

In one embodiment, the phrase of the second sub-information being used to determine whether the type of the first RRC connection procedure is a first type or a second type comprises: the second sub-information implicitly indicates whether the type of the first RRC connection procedure is the first type or the second type.

In one embodiment, the second sub-information comprises at least one RRC IE in the first information.

In one embodiment, the second sub-information comprises at least one RRC field in the first information.

In one embodiment, the second sub-information is an RRC IE in the first information.

In one embodiment, the second sub-information is an RRC field in the first information.

In one embodiment, name of the second sub-information comprises at least one of SDT or small or inactive or data or transmission or type.

In one embodiment, the second sub-information is used to indicate Configured Grant (CG)-SDT to fall back to RA-SDT.

In one embodiment, if the type of the first RRC connection procedure is the first type, RRCResumeRequest is transmitted in a random access procedure.

In one embodiment, if the type of the first RRC connection procedure is the second type, RRCResumeRequest is transmitted on pre-configured uplink resources.

In one embodiment, the first type and the second type are for an SDT.

In one embodiment, the first type refers to an RA-SDT.

In one embodiment, the first type refers to an SDT based on a random access.

In one embodiment, the second type refers to a CG-SDT.

In one embodiment, the second type refers to an SDT based on pre-configured uplink resources.

In one embodiment, the phrase of the type of the first RRC connection procedure being the first type comprises: the first RRC connection procedure is used for an RA-SDT.

In one embodiment, the phrase of the type of the first RRC connection procedure being the first type comprises: the first RRC connection procedure is used for an RA-SDT.

In one embodiment, the phrase of the type of the first RRC connection procedure being the second type comprises: the first RRC connection procedure is used for a CG-SDT.

In one embodiment, the phrase of the first message being transmitted in a random access procedure comprises: the first message being transmitted in Msg3.

In one embodiment, the phrase of the first message being transmitted in a random access procedure comprises: the first message being transmitted in MsgA.

In one embodiment, the phrase of the first message being transmitted in a random access procedure comprises: the first message being transmitted on a PUSCH associated with MsgA.

In one embodiment, the phrase of the first message being transmitted in a random access procedure comprises: the first message being transmitted on UL Grant indicated by a Random Access Response (RAR).

In one embodiment, the phrase of the first message being transmitted in a random access procedure comprises: the first message being transmitted on UL Grant indicated by a fallback RAR.

In one embodiment, the phrase of the first message being transmitted in a random access procedure comprises: the first message being transmitted on UL Grant determined by PUSCH resources associated with MSGA.

In one embodiment, the phrase of the first message being transmitted in a random access procedure comprises: uplink resources used to transmit the first message are determined in a random access procedure.

In one embodiment, the phrase of the first message being transmitted on pre-configured uplink resources comprises: the first message is transmitted on pre-configured PUSCH resources.

In one embodiment, the phrase of the first message being transmitted on pre-configured uplink resources comprises: uplink resources used to transmit the first message are pre-configured.

In one embodiment, if the type of the first RRC connection procedure is the second type, the pre-configured uplink resources are associated with the first cell.

In one embodiment, the pre-configured uplink resources are configured in an RRCRelease message.

In one embodiment, the pre-configured uplink resources are configured in an RRC connected state.

In one embodiment, the pre-configured uplink resources are configured through a System Information Block (SIB).

In one embodiment, the pre-configured uplink resources are used for an SDT.

In one embodiment, the pre-configured uplink resources are SDT-specific.

In one embodiment, the pre-configured uplink resources comprise PUSCH resources.

In one embodiment, the pre-configured uplink resources comprise Preconfigured Uplink Resources (PURs).

In one embodiment, the pre-configured uplink resources are configured for the first node.

In one embodiment, the pre-configured uplink resources are configured for the first cell.

### Embodiment 10

Embodiment 10 illustrates a schematic diagram of first information comprising third sub-information according to one embodiment of the present disclosure.

In embodiment 10, if the type of the first RRC connection procedure is the second type, the first information comprises third sub-information, the third sub-information is used to indicate that second information is not satisfied, and the second condition is any condition in a second condition set; the second condition not being satisfied is used to determine that the type of the first RRC connection procedure is the first type; all conditions in the second condition set being satisfied is used to determine that the type of the first RRC connection procedure is the second type.

In one embodiment, the second condition set is a trigger condition for the first RRC connection procedure with the second type.

In one embodiment, the second condition set not being satisfied and a trigger condition for the type of the first RRC connection procedure being the first type being satisfied are used to determine that the type of the first RRC connection procedure is the first type.

In one embodiment, if the type of the first RRC connection procedure is the first type, the first information does not comprise the third sub-information.

In one embodiment, the phrase of the third sub-information being used to indicate that a second condition is not satisfied comprises: the third sub-information explicitly indicates that the second condition is not satisfied.

In one embodiment, the phrase of the third sub-information being used to indicate that a second condition is not satisfied comprises: the third sub-information implicitly indicates that the second condition is not satisfied.

In one embodiment, the third sub-information is used to indicate a cause that the type of the first RRC connection procedure is the first type.

In one embodiment, the third sub-information is used to indicate a cause that the type of the first RRC connection procedure is not the second type.

In one embodiment, the third sub-information is used to indicate a cause that the type of the first RRC connection procedure falls back from the first type to the second type.

In one embodiment, the third sub-information is used to indicate a cause that a CG-SDT falls back to an RA-SDT.

In one embodiment, the third sub-information is used to indicate a cause that conditions of a CG-SDT are not satisfied.

In one embodiment, as a response to initiating the first RRC connection procedure, and if all conditions in the second condition set are satisfied, it is determined that the type of the first RRC connection procedure is the second type; if the second condition in the second condition set is not satisfied, it is determined that the type of the first RRC connection procedure is the first type.

In one embodiment, as a response to initiating the first RRC connection procedure, the second condition in the second condition set not being satisfied is used to determine that the type of the first RRC connection procedure is the first type.

In one embodiment, as a response to initiating the first RRC connection procedure, at least the second condition in the second condition set not being satisfied is used to determine that the type of the first RRC connection procedure is the first type.

In one embodiment, one condition in the second condition set comprises that whether the first cell is the same as a cell to which the pre-configured uplink resources belong.

In one subembodiment of the embodiment, one condition in the second condition set comprises that the first cell is the same as a cell to which the pre-configured uplink resources belong.

In one subembodiment of the embodiment, one condition in the second condition set comprises that a cell used to request the first RRC connection procedure is the same as a cell to which the pre-configured uplink resources belong.

In one embodiment, one condition in the second condition set is related to an RSRP change value.

In one subembodiment of the embodiment, one condition in the second condition set comprises that an RSRP change value is not greater than an RSRP threshold.

In one subembodiment of the embodiment, the RSRP change value being not greater than an RSRP threshold comprises: an RSRP decrease value is not greater than an RSRP threshold; or, an RSRP increase value is not greater than an RSRP threshold; or, an RSRP decrease value is not greater than an RSRP threshold and an RSRP increase value is not greater than another RSRP threshold.

In one subembodiment of the embodiment, the second condition not being satisfied comprises that an RSRP change value is greater than an RSRP threshold.

In one subembodiment of the embodiment, the RSRP change value being greater than an RSRP threshold comprises: an RSRP decrease value is greater than an RSRP threshold; or, an RSRP increase value is greater than an RSRP threshold; or, an RSRP decrease value is greater than an RSRP threshold or an RSRP increase value is greater than another RSRP threshold.

In one subembodiment of the embodiment, one condition in the second condition set comprises that an RSRP change value is less than an RSRP threshold.

In one subembodiment of the embodiment, the RSRP change value being less than an RSRP threshold comprises: an RSRP decrease value is less than an RSRP threshold; or, an RSRP increase value is less than an RSRP threshold; or, an RSRP decrease value is less than an RSRP threshold and an RSRP increase value is less than another RSRP threshold.

In one subembodiment of the embodiment, the second condition not being satisfied comprises that an RSRP value is not less than an RSRP threshold.

In one subembodiment of the embodiment, the RSRP change value being not less than an RSRP threshold comprises: an RSRP decrease value is not less than an RSRP threshold; or, an RSRP increase value is not less than an RSRP threshold; or an RSRP decrease value is not less than an RSRP threshold or an RSRP increase value is not less than another RSRP threshold.

In one subembodiment of the embodiment, the RSRP is for a cell to which the pre-configured uplink resources belong.

In one subembodiment of the embodiment, the RSRP is for a beam to which the pre-configured uplink resources belong.

In one subembodiment of the embodiment, the RSRP is for an SSB to which the pre-configured uplink resources belong.

In one subembodiment of the embodiment, an RSRP threshold is measured by dBm.

In one subembodiment of the embodiment, an RSRP threshold is measured by dB.

In one subembodiment of the embodiment, an RSRP threshold is pre-configured.

In one subembodiment of the embodiment, one condition in the second condition set is related to a third timer.

In one subembodiment of the embodiment, one condition in the second condition set comprises that the third timer is running.

In one subembodiment of the embodiment, the second condition not being satisfied comprises that the third timer expires.

In one subembodiment of the embodiment, the third timer is associated with the first cell.

In one subembodiment of the embodiment, the third timer is associated with a cell to which the pre-configured uplink resources belong.

In one subembodiment of the embodiment, the third timer is associated with an SSB to which the pre-configured uplink resources belong.

In one subembodiment of the embodiment, a third timer is used to determine a time at which a MAC entity assumes the first cell is uplink time aligned.

In one subembodiment of the embodiment, the third timer is used to determine whether a cell to which the pre-configured uplink resources belong is uplink synchronized.

In one subembodiment of the embodiment, receiving a Timing Advance Command MAC CE is used to determine restarting the third timer.

In one subembodiment of the embodiment, receiving a Timing Advance Command is used to determine restarting the third timer.

In one subembodiment of the embodiment, receiving an Absolute Timing Advance Command is used to determine restarting the third timer.

In one embodiment, one condition in the second condition set is related to a beam.

In one subembodiment of the embodiment, one condition in the second condition set comprises that an RSRP of an SSB associated with the pre-configured uplink resources is not greater than a given threshold.

In one subembodiment of the embodiment, the second condition not being satisfied comprises that an RSRP of an SSB associated with the pre-configured uplink resources is less than a given threshold.

In one subembodiment of the embodiment, one condition in the second condition set comprises that an RSRP of an SSB associated with the pre-configured uplink resources is greater than a given threshold.

In one subembodiment of the embodiment, the second condition not being satisfied comprises that an RSRP of an SSB associated with the pre-configured uplink resources is not greater than a given threshold.

In one embodiment, if the second condition is not satisfied comprises that the third timer expires, the third sub-information indicates that the third timer expires.

In one embodiment, if the second condition is not satisfied comprises that an RSRP change value is greater than an RSRP threshold, the third sub-information indicates that an RSRP change value is greater than an RSRP threshold.

In one embodiment, if the second condition is not satisfied comprises that an RSRP change value is not less than an RSRP threshold, the third sub-information indicates that an RSRP change value is not less than an RSRP threshold.

In one embodiment, if the second condition is not satisfied comprises that an RSRP of an SSB associated with the pre-figured uplink resources is less than a given threshold, the third sub-information indicates that an RSRP of an SSB associated with the pre-configured uplink resources is less than a given threshold.

In one embodiment, if the second condition is not satisfied comprises that an RSRP of an SSB associated with the pre-figured uplink resources is not greater a given threshold, the third sub-information indicates that an RSRP of an SSB associated with the pre-configured uplink resources is not greater than a given threshold.

In one embodiment, the behavior of initiating the first RRC connection procedure is taken before the behavior of transmitting a first message.

In one embodiment, the behavior of initiating the first RRC connection procedure comprises setting contents of the first message.

In one embodiment, as a response to initiating the first RRC connection procedure, if all conditions in the second condition set are satisfied, it is determined that the type of the first RRC connection procedure is the second type; if any condition in the second condition set is not satisfied, it is determined that the type of the first RRC connection procedure is the first type.

In one embodiment, as a response to initiating the first RRC connection procedure, if all conditions in the second condition set are satisfied, it is determined that the type of the first RRC connection procedure is the second type; if any condition in the second condition set is not satisfied, and a trigger condition of the first RRC connection procedure with the first type is satisfied, it is determined that the type of the first RRC connection procedure is the first type.

### Embodiment 11

Embodiment 11 illustrates a schematic diagram of whether first failure information comprises second information being related to at least former of a first condition and a first RRC connection procedure according to one embodiment of the present disclosure, as shown in FIG. 11.

In embodiment 11, whether the first failure information comprises second information is related to at least a former of the first condition and the type of the first RRC connection procedure; the second information is used to indicate random access information.

In one embodiment, the meaning of the phrase of whether the first failure information comprises second information being related to at least a former of the first condition and the type of the first RRC connection procedure comprises: whether the first failure information comprises second information is related to whether at least the first RRC connection procedure is used for an SDT.

In one subembodiment of the embodiment, if the first RRC connection procedure is not used for an SDT, the first failure information comprises the second information.

In one subembodiment of the embodiment, if the first RRC connection procedure is used for an SDT, whether the first failure information comprises the second information is related to the type of the first RRC connection procedure.

In one subembodiment of the embodiment, the first RRC connection procedure is used for an SDT, and the type of the first RRC connection procedure is the first type, the first failure information comprises the second information.

In one subembodiment of the embodiment, if the first RRC connection procedure is used for an SDT, and the type of the first RRC connection procedure is the second type, the first failure information does not comprise the second information.

In one embodiment, if the first condition is that the first timer expires and the first timer is the target timer, whether the first failure information comprises second information is unrelated to the first RRC connection procedure.

In one embodiment, if the first condition is any condition in the first condition set, whether the first failure information comprises second information is related to the type of the first RRC connection procedure.

In one embodiment, if the first condition is that the first timer expires and the first timer is the target timer, the first failure information comprises the second information.

In one embodiment, if the first condition is any condition in the first condition set, and a type of a first RRC connection procedure is the first type, the first failure information comprises the second information.

In one embodiment, if the first condition is any condition in the first condition set, and a type of a first RRC connection procedure is the second type, the first failure information does not comprise the second information.

In one embodiment, a random access procedure associated with the random access information is triggered by the first message.

In one embodiment, a random access procedure associated with the random access information is used to request uplink resources of the first message.

### Embodiment 12

Embodiment 12 illustrates a structure block diagram of a processor in a first node according to one embodiment of the present application, as shown in FIG. 12. In FIG. 12, a processor 1200 in a first node comprises a first receiver 1201 and a first transmitter 1202.

The first transmitter 1202 transmits a first message on a first cell, the first message is used to request a first RRC connection procedure; accompanying the first message, starts a first timer;

the first receiver 1201, as a response to a first condition being satisfied, determines the first RRC connection procedure failure; as a response to determining the first RRC connection procedure failure, stores first failure information in a first variant;

in embodiment 12, when the first message is transmitted, the first node is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T319, or the target timer is T300.

In one embodiment, the first variant is associated with that the first timer expires and the first timer is the target timer, and name of the first variant comprises VarConnEstFailReport; or, the first condition is any condition in the first condition set, and the first variant is a first candidate variant.

In one embodiment, conditions in the first condition set also comprise at least one of a maximum number of RLC retransmissions having been reached, or timer T310 being expired, or occurring LBT failure, or occurring BFR failure, or occurring random access failure.

In one embodiment, the first information comprises first sub-information, and the first sub-information is used to indicate the first condition.

In one embodiment, the first information comprises second sub-information, and the second sub-information is used to determine whether a type of the first RRC connection procedure is a first type or a second type; if the type of the first RRC connection procedure is the first type, the first message is transmitted in a random access procedure; and if the type of the first RRC connection procedure is the second type, the first message is transmitted on pre-configured uplink resources.

In one embodiment, if the type of the first RRC connection procedure is the second type, the first information comprises third sub-information, the third sub-information is used to indicate that second information is not satisfied, and the second condition is any condition in a second condition set; the second condition not being satisfied is used to determine that the type of the first RRC connection procedure is the first type; all conditions in the second condition set being satisfied is used to determine that the type of the first RRC connection procedure is the second type.

In one embodiment, whether the first failure information comprises second information is related to at least a former of the first condition and the type of the first RRC connection procedure; the second information is used to indicate random access information.

In one embodiment, the first transmitter 1202, after the first RRC connection procedure is determined failed, transmits a second message on a second cell, the second message is used to request a second RRC connection procedure; accompanying the second message, starts a second timer; the first receiver 1201, as a response to the second timer being expired, determines the second RRC connection procedure failure; as a response to determining the second RRC connection procedure failure, clears target information in the first variant, and stores second failure information in the first variant; herein, the second failure information comprises a second measurement result, and the second measurement result is associated with the second cell; the target information does not comprise at least partial information in the first failure information.

In one embodiment, the first receiver 1201, as a response to determining the first RRC connection procedure failure, determines whether a first counter is increased by 1 according to whether the first RRC connection procedure is used for an SDT; herein, the first variant comprises the first counter; the behavior of whether the first counter is increased by 1 according to whether the first RRC connection procedure is used for an SDT comprises: if the first RRC connection procedure is not used for an SDT, increasing the first counter by 1; if the first RRC connection procedure is used for an SDT, not increasing the first counter by 1.

In one embodiment, the first receiver 1201, during when the first timer is running, monitors a candidate message.

In one embodiment, the first transmitter 1202, as a response to receiving the target signaling, transmits a first-type sub-message.

In one embodiment, the first receiver 1201, as a response to the first-type sub-message being transmitted, receives a first-type sub-signaling.

In one embodiment, the first receiver 1201, as a response to the first message being transmitted, receives a target signaling.

In one embodiment, the first transmitter 1202, accompanying the first-type sub-message, restarts the first timer.

In one embodiment, the first transmitter 1202 transmits a third message, and the third message indicates whether there exists the first failure information.

In one embodiment, the first receiver 1201 receives a fourth message, and the fourth message is used to request reporting the first failure information; the first transmitter 1201, as a response to receiving the fourth message, transmits a fifth message, and the fifth message comprises the first failure information.

In one embodiment, the first receiver 1201 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises the antenna 452, the receiver 454, the multi-antenna receiving processor 458 and the receiving processor 456 in FIG. 4 of the present application.

In one embodiment, the first receiver 1201 comprises the antenna 452, the receiver 454 and the receiving processor 456 in FIG. 4 of the present application.

In one embodiment, the first transmitter 1202 comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202 comprises the antenna 452, the transmitter 454, the multi-antenna transmitting processor 457 and the transmitting processor 468 in FIG. 4 of the present application.

In one embodiment, the first transmitter 1202 comprises the antenna 452, the transmitter 454 and the transmitting processor 468 in FIG. 4 of the present application.

### Embodiment 13

Embodiment 13 illustrates a structure block diagram of a processor in a second node according to one embodiment of the present application, as shown in FIG. 13. In FIG. 13, a processor 1300 of a second node comprises a second transmitter 1301 and a second receiver 1302.

The second receiver 1302 receives a first message on a first cell, the first message is used to request a first RRC connection procedure;

in embodiment 13, accompanying the first message, a first timer is started; as a response to a first condition being satisfied, the first RRC connection procedure is determined to be failed; as a response to that the first RRC connection procedure is determined to be failed, first failure information is stored in a first variant; when the first message is transmitted, a transmitter of the first message is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprise the first information; or, the first condition is any condition in a first condition set, and the first failure information comprises the first information; one condition in the first condition set is that the first timer expires and the first timer is a timer other than a target timer; the target timer is T319, or the target timer is T300.

In one embodiment, the first variant is associated with that the first timer expires and the first timer is the target timer, and name of the first variant comprises VarConnEstFailReport; or, the first condition is any condition in the first condition set, and the first variant is a first candidate variant.

In one embodiment, conditions in the first condition set also comprise at least one of a maximum number of RLC retransmissions having been reached, or timer T310 being expired, or occurring LBT failure, or occurring BFR failure, or occurring random access failure.

In one embodiment, the first information comprises first sub-information, and the first sub-information is used to indicate the first condition.

In one embodiment, the first information comprises second sub-information, and the second sub-information is used to determine whether a type of the first RRC connection procedure is a first type or a second type; if the type of the first RRC connection procedure is the first type, the first message is transmitted in a random access procedure; and if the type of the first RRC connection procedure is the second type, the first message is transmitted on pre-configured uplink resources.

In one embodiment, if the type of the first RRC connection procedure is the second type, the first information comprises third sub-information, the third sub-information is used to indicate that second information is not satisfied, and the second condition is any condition in a second condition set; the second condition not being satisfied is used to determine that the type of the first RRC connection procedure is the first type; all conditions in the second condition set being satisfied is used to determine that the type of the first RRC connection procedure is the second type.

In one embodiment, whether the first failure information comprises second information is related to at least a former of the first condition and the type of the first RRC connection procedure; the second information is used to indicate random access information.

In one embodiment, a second message is received on a second cell, and the second message is used to request a second RRC connection procedure; after the first RRC connection procedure is determined failed, the second message is triggered; accompanying the second message, a second timer is started; as a response to the second timer being expired, the second RRC connection procedure is determined failed; as a response to the second RRC connection procedure being determined failed, target information in the first variant is cleared, and second failure information is stored in the first variant; the second failure information comprises a second measurement result, and the second measurement result is associated with the second cell; the target information does not comprise at least partial information in the first failure information.

In one embodiment, as a response to the first RRC connection procedure being determined failed, whether the first RRC connection procedure is used for an SDT is used to determine whether a first counter is increased by 1; the first variant comprises the first counter; the phrase of whether the first RRC connection procedure is used for an SDT being used to determine whether a first counter is increased by 1 comprises: if the first RRC connection procedure is not used for an SDT, the first counter is increased by 1; if the first RRC connection procedure is used for an SDT, the first counter is not increased by 1;

In one embodiment, the second transmitter 1301, after receiving the first message, transmits a candidate message.

In one embodiment, the second receiver 1302, as a response to transmitting the target signaling, receives a first-type sub-message.

In one embodiment, the second transmitter 1301, as a response to the first-type sub-message being received, transmits a first-type sub-signaling.

In one embodiment, the second transmitter 1301, as a response to the first message being received, transmits a target signaling.

In one embodiment, the second transmitter 1301 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises the antenna 420, the transmitter 418, the multi-antenna transmitting processor 471 and the transmitting processor 416 in FIG. 4 of the present application.

In one embodiment, the second transmitter 1301 comprises the antenna 420, the transmitter 418 and the transmitting processor 416 in FIG. 4 of the present application.

In one embodiment, the second receiver 1302 comprises the antenna 420, the receiver 418, the multi-antenna receiving processor 472, the receiving processor 470, the controller/processor 475 and the memory 476 in FIG. 4 of the present application.

In one embodiment, the second receiver 1302 comprises the antenna 420, the receiver 418, the multi-antenna receiving processor 472 and the receiving processor 470 in FIG. 4 of the present application.

In one embodiment, the second receiver 1302 comprises the antenna 420, the receiver 418 and the receiving processor 470 in FIG. 4 of the present application.

### Embodiment 14

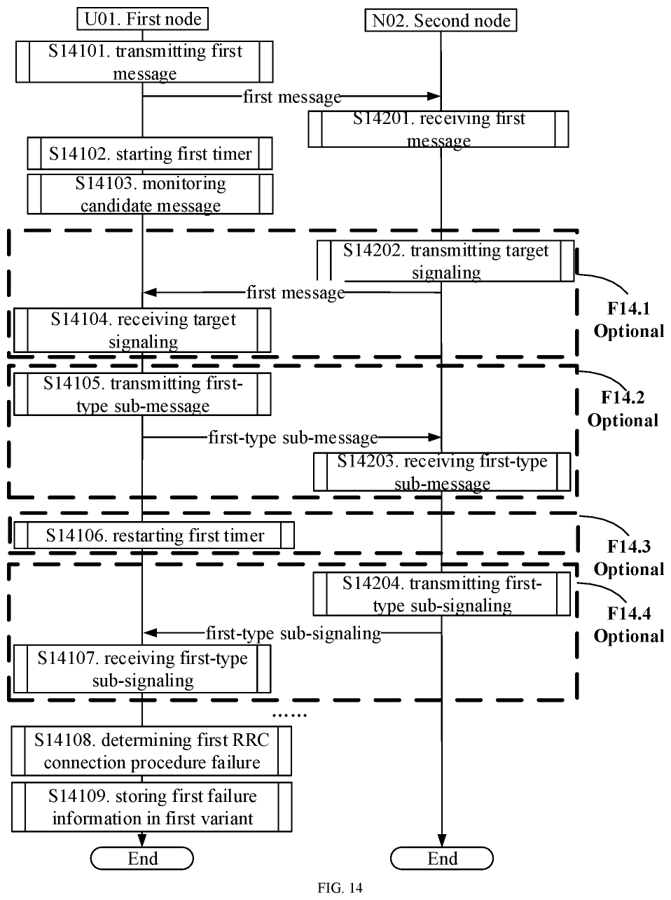

Embodiment 14 illustrates a flowchart of radio signal transmission according to another embodiment of the present application, as shown in FIG. 14. It is particularly underlined that the order illustrated in the embodiment does not put constraints over sequences of signal transmissions and implementations.

The first node U01, in step S14101, transmits a first message on a first cell, the first message is used to request a first RRC connection procedure; in step S14102, accompanying the first message, starts a first timer; in step S14103, during when the first timer is running, monitors a candidate message; in step S14104, as a response to the first message being transmitted, receives a target signaling; in step S14105, as a response to receiving the target signaling, transmits a first-type sub-message; in step S14106, accompanying the first-type sub-message, restarts the first timer; in step S14107, as a response to the first-type sub-message being transmitted, receives a first-type sub-signaling; in step S14108, as a response to a first condition being satisfied, determines the first RRC connection procedure failure; in step S14109, as a response to determining that the first RRC connection procedure fails, stores first failure information in a first variant.

The second node N02, in step S14201, receives the first message; in step S14202, transmits the target signaling; in step S14203, receives the first-type sub-message; in step S14204, transmits the first-type sub-signaling.

In embodiment 14, when the first message is transmitted, the first node is not in an RRC_CONNECTED State; the first failure information comprises a first measurement result, and the first measurement result is associated with the first cell; the first condition is any condition in a first condition set, and the first failure information comprises the first information; one condition in the first condition set is that the first timer expires and the first timer is a timer other than a target timer; the target timer is T319; the non-RRC connected state is an RRC-INACTIVE state.

In one embodiment, the first variant is associated with that the first timer expires and the first timer is the target timer, and name of the first variant comprises VarConnEstFailReport.

In one embodiment, the first variant is a first candidate variant.

In one embodiment, the box F14.1 framed with dotted lines is optional.

In one embodiment, the box F14.1 framed with dotted lines exists.

In one embodiment, the box F14.1 framed with dotted lines does not exist.

In one embodiment, the dotted box F14.1 does not exist refers to that at least the step S14104 in the dotted box F14.1 does not exist.

In one embodiment, the box F14.2 framed with dotted lines is optional.

In one embodiment, the box F14.2 framed with dotted lines exists.

In one embodiment, the box F14.2 framed with dotted lines does not exist.

In one embodiment, the dotted box F14.2 does not exist refers to that at least the step S14203 in the dotted box F14.2 does not exist.

In one embodiment, the box F14.3 framed with dotted lines is optional.

In one embodiment, the box F14.3 framed with dotted lines exists.

In one subembodiment of the above embodiment, the step S14106 is before the step S14105.

In one subembodiment of the above embodiment, the step S14106 is after the step S14105.

In one embodiment, the box F14.3 framed with dotted lines does not exist.

In one embodiment, the box F14.4 framed with dotted lines is optional.

In one embodiment, the box F14.4 framed with dotted lines exists.

In one embodiment, the box F14.4 framed with dotted lines does not exist.

In one embodiment, the dotted box F14.4 does not exist refers to that at least the step S14107 in the dotted box F14.4 does not exist.

In one embodiment, the dotted box F14.1, the dotted box F14.2 and the dotted box F14.4 do not exist.

In one embodiment, at least a former of the dotted box F14.1 or the dotted box F14.2 or the dotted box F14.4 exists.

In one embodiment, at least first two of the dotted box F14.1 or the dotted box F14.2 or the dotted box F14.4 exists.

In one embodiment, the dotted box F14.1, the dotted box F14.2 and the dotted box F14.4 exist.

In one embodiment, the step S14101 is taken before the step S14102.

In one embodiment, the step S14101 is taken after the step S14102.

In one embodiment, the ellipsis indicates other first-type sub-signalings or a first-type message.

In one embodiment, the ellipsis is optional.

In one embodiment, the ellipsis exists.

In one embodiment, the ellipsis does not exist.

### Embodiment 15

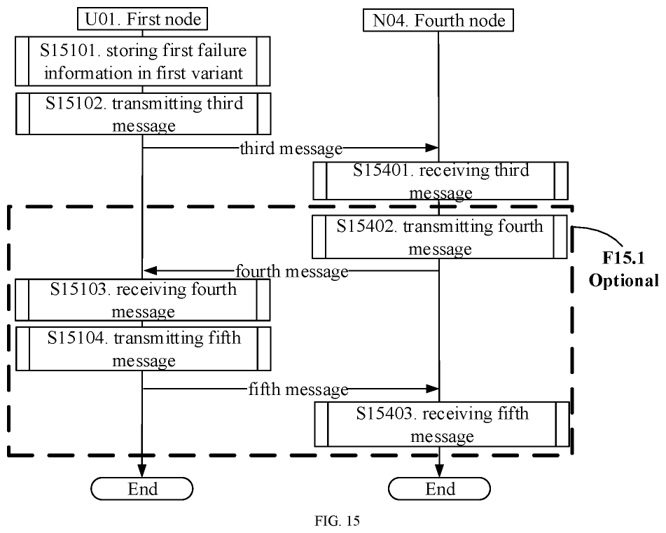

Embodiment 15 illustrates a flowchart of radio signal transmission according to another embodiment of the present disclosure, as shown in FIG. 15. It is particularly underlined that the order illustrated in the embodiment does not put constraints over sequences of signal transmissions and implementations.

The first node U01, in step S15101, as a response to determining that the first RRC connection procedure fails, stores first failure information in a first variant; in step S15102, transmits a third message, the third message indicates whether there exists the first failure information; in step S15103, receives a fourth message, and the fourth message is used to request reporting the first failure information; in step S15104, as a response to receiving the fourth message, transmits a fifth message, and the fifth message comprises the first failure information.

The fourth node N04, in step S15401, receives the third message; in step S15402, transmits the fourth message; in step S15403, receives the fifth message.

In one embodiment, the fourth node N04 is a base station.

In one embodiment, the fourth node N04 is the same as the second node.

In one embodiment, the fourth node N04 is different from the second node.

In one embodiment, the fourth node N04 is the same as the third node.

In one embodiment, the fourth node N04 is different from the third node.

In one embodiment, the fourth node N04 is not the second node or the third node.

In one embodiment, the third message comprises an RRC message.

In one embodiment, the third message indicates whether there exists the first failure information when the third message is set.

In one embodiment, the third message comprises an RRCReestablishmentComplete message.

In one embodiment, the third message comprises an RRCReconfigurationComplete message.

In one embodiment, the third message comprises an RRCSetupComplete message.

In one embodiment, the third message comprises an RRC IE, and name of the RRC IE comprises UE-MeasurementsAvailable.

In one embodiment, in the process of the third message being set, if there exists the first failure information in the first variant, the third message comprises the first field.

In one embodiment, in the process of the third message being set, if there exists the first failure information in the first variant, the first field in the third message is set as true.

In one embodiment, in the process of the third message being set, if there does not exist the first failure information in the first variant, the third message does not comprise the first field.

In one embodiment, the first field is an RRC field, and name of the RRC field comprises connEstFailInfoAvailable; name of the first variant comprises VarConnEstFailReport.

In one embodiment, the first field is an RRC field, and name of the RRC field comprises rlf-InfoAvailable; the first variant is the first candidate variant, and name of the first candidate variant comprises VarRLF-Report.

In one embodiment, the first field is an RRC field, and name of the RRC field comprises at least Available, and name of the RRC field do not comprise rlf-InfoAvailable or connEstFailInfoAvailable; the first variant is the first candidate variant, and the first candidate variant is not VarRLF-Report.

In one embodiment, the first field is an RRC field, and name of the RRC field comprises at least one of sdt or idt or small or inactive or data or transmission or trans or failure or fail or Available, and name of the RRC field do not comprise rlf-InfoAvailable or connEstFailInfoAvailable; the first variant is the first candidate variant, and the first candidate variant is not VarRLF-Report.

In one embodiment, the third message comprising a first field is used to indicate that there exists the first failure information, and the third message not comprising the first field is used to indicate that there does not exist the first failure information.

In one embodiment, a first field in the third message being set as true indicates that there exists the first failure information.

In one embodiment, there existing the first failure information in the first variant is used to determine that there exists the first failure information.

In one embodiment, there not existing the first failure information in the first variant is used to determine that there does not exist the first failure information.

In one embodiment, before the third message is transmitted, the first failure information being deleted is used to determine that there does not exist the first failure information.

In one embodiment, before the third message is transmitted, the first failure information not being deleted is used to determine that there exists the first failure information.

In one embodiment, if X1 hours are elapsed since the first RRC connection process was determined failed, the first failure information is deleted.

In one subembodiment of the above embodiment, X1 is a positive integer.

In one subembodiment of the above embodiment, X1 is equal to 24.

In one subembodiment of the above embodiment, X1 is equal to 48.

In one embodiment, the fourth message comprises an RRC message.

In one embodiment, the fourth message is used to request reporting the first failure information.

In one embodiment, the fourth message comprises a UEInformationRequest message.

In one embodiment, the fourth message comprising a second field is used to request reporting the first failure information.

In one embodiment, a second field in the fourth message being set as true is used to request reporting the first failure information.

In one embodiment, the second field in the fourth message is an RRC field, and name of the RRC field comprises connEstFailReportReq; name of the first variant comprises VarConnEstFailReport.

In one embodiment, the second field in the fourth message is an RRC field, and name of the RRC field comprises rlf-ReportReq; the first variant is the first candidate variant, and name of the first candidate variant comprises VarRLF-Report.

In one embodiment, the second field in the fourth message is an RRC field, name of the RRC field comprises at least Req, and name of the RRC field do not comprise rlf-ReportReq or connEstFailReportReq; the first variant is the first candidate variant, and the first candidate variant is not VarRLF-Report.

In one embodiment, the second field in the fourth message is an RRC field, name of the RRC field comprises at least one of sdt or idt or small or inactive or data or transmission or trans or failure or fail or Req, and name of the RRC field does not comprise rlf-ReportReq or connEstFailReportReq; the first variant is the first candidate variant, and the first candidate variant is not VarRLF-Report.

In one embodiment, the fifth message comprises an RRC message.

In one embodiment, the fifth signaling comprises a UEInformationResponse message.

In one embodiment, a third field in the fifth message comprises the first failure information.

In one embodiment, the third field in the fifth message is an RRC field, and name of the RRC field comprises rlf-Report; the first variant is the first candidate variant, and name of the first candidate variant comprises VarRLF-Report.

In one embodiment, the third field in the fifth message is an RRC field, and name of the RRC field comprises connEstFailReport; name of the first variant comprises VarConnEstFailReport.

In one embodiment, the third field in the fifth message is an RRC field, and name of the RRC field comprises at least Report; the first variant is the first candidate variant, and the first candidate variant is not VarRLF-Report.

In one embodiment, the third field in the fifth message is an RRC field, name of the RRC field comprises at least one of sdt or idt or small or inactive or data or transmission or trans or failure or fail or Report, and name of the RRC field do not comprises rlf-Report or connEstFailReport; the first variant is the first candidate variant, and the first candidate variant is not VarRLF-Report.

In one embodiment, the fifth message comprises the first failure information.

In one embodiment, the fifth message does not comprise the first failure information.

In one embodiment, if the second field in the fourth message is set as true, there exists the first failure information in the first variant, and RPLMN is stored in the first variant, a third field in the fifth message is set as the first failure information.

In one embodiment, if the fourth message comprises the second field, there exists the first failure information in the first variant, and RPLMN is stored in the first variant, a third field in the fifth message is set as the first failure information.

In one embodiment, when the third message is transmitted, there exists the first failure message.

In one embodiment, when the third message is transmitted, there does not exist the first failure message.

In one embodiment, the box F15.1 framed with dotted lines is optional.

In one embodiment, the box F15.1 framed with dotted lines exists.

In one embodiment, the box F15.1 framed with dotted lines does not exist.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first transmitter, transmitting a first message on a first cell, the first message being used to request a first RRC connection procedure; accompanying the first message, starting a first timer; and
a first receiver, as a response to a first condition being satisfied, determining that the first RRC connection procedure fails; as a response to determining that the first RRC connection procedure fails, storing first failure information in a first variant;
wherein when the first message is transmitted, the first node is not in a RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprises the first information; or, the first condition is any condition in a first condition set, and the first failure information comprises the first information; one condition in the first condition set is that the first timer expires and the first timer is a timer other than a target timer; the target timer is T319, or the target timer is T300.

2. The first node according to claim 1, wherein the first variant is associated with that the first timer expires and the first timer is the target timer, and name of the first variant comprises VarConnEstFailReport; or, the first condition is any condition in the first condition set, and the first variant is a first candidate variant.

3. The first node according to claim 1, wherein conditions in the first condition set also comprise at least one of a maximum number of RLC retransmissions having been reached, or timer T310 being expired, or occurring LBT failure, or occurring BFR failure, or occurring random access failure.

4. The first node according to claim 1, wherein the first information comprises first sub-information, and the first sub-information is used to indicate the first condition.

5. The first node according to claim 1, wherein the first information comprises second sub-information, and the second sub-information is used to determine whether a type of the first RRC connection procedure is a first type or a second type; if the type of the first RRC connection procedure is the first type, the first message is transmitted in a random access procedure; and if the type of the first RRC connection procedure is the second type, the first message is transmitted on pre-configured uplink resources.

6. The first node according to claim 5, wherein if the type of the first RRC connection procedure is the second type, the first information comprises third sub-information, the third sub-information is used to indicate that second information is not satisfied, and the second condition is any condition in a second condition set; the second condition not being satisfied is used to determine that the type of the first RRC connection procedure is the first type; all conditions in the second condition set being satisfied is used to determine that the type of the first RRC connection procedure is the second type.

7. The first node according to claim 5, wherein whether the first failure information comprises second information is related to at least a former of the first condition and the type of the first RRC connection procedure; the second information is used to indicate random access information.

8. The first node according to claim 1, comprising:
the first transmitter, after the first RRC connection procedure is determined failed, transmitting a second message on a second cell, the second message being used to request a second RRC connection procedure; accompanying the second message, starting a second timer; and
the first receiver, as a response to the second timer being expired, determining the second RRC connection procedure failure; as a response to determining the second RRC connection procedure failure, clearing target information in the first variant, and storing second failure information in the first variant;
wherein the second failure information comprises a second measurement result, and the second measurement result is associated with the second cell; the target information does not comprise at least partial information in the first failure information.

9. The first node according to claim 1, comprising:
the first receiver, as a response to determining that the first RRC connection procedure is failed, determining whether a first counter is increased by 1 according to whether the first RRC connection procedure is used for an SDT;
wherein the first variant comprises the first counter; the behavior of whether the first counter is increased by 1 according to whether the first RRC connection procedure is used for an SDT comprises: if the first RRC connection procedure is not used for an SDT, increasing the first counter by 1; if the first RRC connection procedure is used for an SDT, not increasing the first counter by 1.

10. The first node according to claim 1, comprising:
the first transmitter, transmitting a third message, the third message indicating whether there exists the first failure information;
the first receiver, receiving a fourth message, the fourth message being used to request reporting the first failure information; and
the first transmitter, as a response to receiving the fourth message, transmitting a fifth message, and the fifth message comprising the first failure information.

11. The first node according to claim 1, comprising:
the first receiver or the first transmitter, if the first RRC connection procedure is used for an SDT, accompanying the first message, resuming a first bearer;
wherein the first bearer is a data radio bearer.

12. The first node according to claim 1, comprising:
the first receiver or the first transmitter, as a response to determining that the first RRC connection procedure failure, clearing at least partial information in the first variant, and storing the first failure information in the first variant.

13. The first node according to claim 1, comprising:
the first receiver or the first transmitter, as a response to determining that the first RRC connection procedure failure, clearing all information in the first variant, and stores the first failure information in the first variant.

14. The first node according to claim 1, comprising:
the first receiver or the first transmitter, as a response to determining that the first RRC connection procedure fails, clearing all information other than a first timer in the first variant, and storing the first failure information in the first variant.

15. A second node for wireless communications, comprising:
a second receiver, receiving a first message on a first cell, the first message being used to request a first RRC connection procedure;
wherein accompanying the first message, a first timer is started; as a response to a first condition being satisfied, the first RRC connection procedure is determined to be failed; as a response to that the first RRC connection procedure is determined to be failed, first failure information is stored in a first variant; when the first message is transmitted, a transmitter of the first message is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprises the first information; or, the first condition is any condition in a first condition set, and the first failure information comprises the first information; one condition in the first condition set is that the first timer expires and the first timer is a timer other than a target timer; the target timer is T319, or the target timer is T300.

16. The second node according to claim 15, wherein the first variant is associated with that the first timer expires and the first timer is the target timer, and name of the first variant comprises VarConnEstFailReport; or, the first condition is any condition in the first condition set, and the first variant is a first candidate variant.

17. The second node according to claim 15, wherein the first information comprises second sub-information, and the second sub-information is used to determine whether a type of the first RRC connection procedure is a first type or a second type; if the type of the first RRC connection procedure is the first type, the first message is transmitted in a random access procedure; and if the type of the first RRC connection procedure is the second type, the first message is transmitted on pre-configured uplink resources.

18. The second node according to claim 17, wherein whether the first failure information comprises second information is related to at least a former of the first condition and the type of the first RRC connection procedure; the second information is used to indicate random access information.

19. A method in a first node for wireless communications, comprising:
transmitting a first message on a first cell, the first message being used to request a first RRC connection procedure; accompanying the first message, starting a first timer; and
as a response to a first condition being satisfied, determining the first RRC connection procedure failure; as a response to determining that the first RRC connection procedure fails, storing first failure information in a first variant;
wherein when the first message is transmitted, the first node is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprises the first information; or, the first condition is any condition in a first condition set, and the first failure information comprises the first information; one condition in the first condition set is that the first timer expires and the first timer is a timer other than a target timer; the target timer is T319, or the target timer is T300.

20. A method in a second node for wireless communications, comprising:
receiving a first message on a first cell, the first message being used to request a first RRC connection procedure;
wherein accompanying the first message, a first timer is started; as a response to a first condition being satisfied, the first RRC connection procedure is determined to be failed; as a response to that the first RRC connection procedure is determined to be failed, first failure information is stored in a first variant; when the first message is transmitted, a transmitter of the first message is not in an RRC_CONNECTED State; the first failure information comprises a first measurement result, and the first measurement result is associated with the first cell; whether the first failure information comprises first information is associated with the first condition; the first condition is that the first timer expires and the first timer is a target timer, and the first failure information does not comprises the first information; or, the first condition is any condition in a first condition set, and the first failure information comprises the first information; one condition in the first condition set is that the first timer expires and the first timer is a timer other than a target timer; the target timer is T319, or the target timer is T300.
